(19) United States
(12) Patent Application Publication
(10) Pub. No.: US 2010/0295929 A1
(43) Pub. Date: Nov. 25, 2010

(54) SYNCHRONIZATION CIRCUITS AND METHODS USABLE IN SHUTTER GLASSES

(75) Inventors: Kazunari Yoshifuji, Tokyo (JP); Isao Ohashi, Kanagawa (JP); Tsutomu Nigami, Tokyo (JP); Atsuhiro Chiba, Tokyo (JP)

Correspondence Address: WOLF GREENFIELD & SACKS, P.C., 600 ATLANTIC AVENUE, BOSTON, MA, 02210-2206, US

(73) Assignee: Sony Corporation, Tokyo (JP)

(21) Appl. No.: 12/781,948

(22) Filed: May 18, 2010

(30) Foreign Application Priority Data
May 25, 2009 (JP) 2009-125250

(51) Int. Cl. H04N 13/04

(52) U.S. Cl. 348/53; 348/56; 348/E13.075

(57) ABSTRACT

Described herein are circuits and methods enabling a user to view 3D video using shutter glasses. The shutter glasses can wirelessly receive a video synchronization signal to synchronize the timing of a shutter operation with the timing of displayed video. A self-timing signal can be generated based on a measured period of the video synchronization signal. A low-power mode of operation can be entered for a period of time in which reception of the video synchronization signal is disabled and the shutter operation is controlled based on the self-timing signal.

### BACKGROUND OF THE INVENTION

1. Field of the Invention

The present invention relates to synchronization circuits and methods usable in shutter glasses for viewing 3D video. More particularly, the present invention relates to synchronization circuits and methods capable of decreasing power consumption.

2. Description of the Related Art

The proliferation of television sets referred to as flat panel displays, such as liquid crystal displays (LCDs) and plasma display panels (PDPs), is rapidly advancing in recent years. Furthermore, terrestrial digital broadcasts began in Japan in December 2003, enabling users to view high-quality, high-definition content at home. Moreover, recent years have seen rapid uptake of high-definition recorders and media players, thereby helping to establish a home environment where users are able to view not only high-definition broadcasts, but also high-definition packaged media. In these circumstances, flat panel displays enabling the viewing of three-dimensional (3D) stereoscopic picture content are also being successively announced.

The methods for viewing 3D stereoscopic content can be roughly classified into two types: glasses methods, which use polarizing filter glasses or shutter glasses; and naked eye methods, which use lenticular, parallax barrier, or similar methods that do not involve glasses. Among these methods, it is anticipated that glasses methods will become widespread in the near future for home viewing, in consideration of compatibility with two-dimensional picture display.

FIG. 1 illustrates the principle behind viewing a 3D stereoscopic picture using shutter glasses.

On the display 1, the following are displayed in a time series: a left-eye picture L1, a right-eye picture R1, a left-eye picture L2, a right-eye picture R2, a left-eye picture L3, a right-eye picture R3, and so on, with left-eye pictures being displayed in alternation with right-eye pictures.

Meanwhile, the user viewing the 3D stereoscopic pictures wears the shutter glasses 2. The shutter glasses 2 are supplied with a synchronization (sync) signal in the form of the vertical sync signal of the pictures. The shutter glasses 2 may include liquid crystal devices with different polarizations for the left eye and right eye, respectively. The liquid crystal devices alternately repeat the following two shutter operations in sync with the sync signal: left-eye open, right-eye closed; and left-eye closed, right-eye open. As a result, only right-eye pictures are input into the user's right eye, and only left-eye pictures are input into the user's left eye. Parallax is provided between the left-eye pictures and the right-eye pictures, and as a result of these two-dimensional pictures with parallax, the user is able to perceive a 3D stereoscopic picture.

In consideration of comfort while viewing, in many cases the sync signal provided to the shutter glasses 2 is wirelessly transmitting by infrared or similar techniques. However, communication by infrared is highly directional, and thus has the drawback of the incoming signals becoming weaker when the receiver is no longer directly in front of the transmitter.

FIG. 2 illustrates the emission characteristics of an infrared-emitting diode adopted for use as a transmitter for infrared communication. In FIG. 2, the emission characteristics are shown by taking the reference strength (100%) to be the emission strength directly in front (0°) of the infrared-emitting diode.

As shown in FIG. 2, the signal strength of the infrared-emitting diode drops sharply outside of the range from 10° to 20°. Once 30° is exceeded, almost no signal is received.

For this reason, it is conceivable to cover the user's viewing range by using a plurality of infrared-emitting diodes, as shown by way of example in FIG. 3.

Generally, the relative positions of the display 1 and the user who views 3D stereoscopic pictures displayed thereon are taken to obtain a suitable relationship like that shown in FIG. 4. In other words, the suitable user viewing range 3 for viewing a 3D stereoscopic picture is taken to be a fan-shaped region whose radius L is three times the vertical length 1 of the screen in the display 1.

Consequently, the user viewing range 3 depends on the screen size of the display 1. Due to the recent proliferation of large flat panel displays, the user viewing range 3 is increasing in size. For this reason, it is becoming difficult to cover the user viewing range 3 by using a plurality of infrared-emitting diodes as shown in FIG. 3. If the sync signal is not reliably received, then the shutter glasses 2 might not shutter in sync with the left-eye and right-eye pictures. Such a situation might not only prevent the user from properly viewing the 3D stereoscopic picture, but furthermore lead to user discomfort due to the irregular shuttering. Moreover, by using a plurality of infrared-emitting diodes, there is an additional problem in that power consumption is increased at the transmitting side.

Meanwhile, when considering that the shutter glasses 2 at the receiving side wirelessly receive a sync signal and are made to operate independently by means of a battery, it is demanded that power consumption be curtailed as much as possible, and that the shutter glasses 2 be able to withstand long hours of use.

For example, in Japanese Patent No. 3270886, the present applicant has proposed shutter glasses wherein low power consumption is realized by providing a controller that blocks power supply to the receiver that receives sync signals during periods other than an active period when a sync signal is being received.

### SUMMARY OF THE INVENTION

However, further decreases in power consumption are desired in the shutter glasses 2 on the receiving side.

In light of the foregoing circumstances, it is desirable to provide a signal receiving apparatus, shutter glasses, and a signal transmission system configured such that power consumption can be further decreased.

According to an embodiment of the present invention, power consumption can be further decreased.

Some embodiments relate to a method of synchronizing a shutter operation of shutter glasses with a video synchronization signal for displayed video. The shutter glasses can provide a wearer with a perception of viewing three dimensional video. The method is performed at the shutter glasses. In the method, a video synchronization signal is received. A self-timing signal is generated that is synchronized with the video synchronization signal. A low-power mode of operation is entered in which reception of the video synchronization signal is disabled. The shutter operation is controlled based on the self-timing signal. The low-power mode is exited to enable reception of the video synchronization signal. The self-timing signal is re-synchronized with the video synchronization signal.

Some embodiments relate to a circuit for synchronizing a shutter operation of shutter glasses with a video synchronization signal for displayed video. The shutter glasses can provide a wearer with a perception of viewing three dimensional video. The circuit includes a receiver configured to receive the video synchronization signal. The circuit also includes a timing generator configured to generate a self-timing signal synchronized with the video synchronization signal. The circuit further includes a controller configured to switch the circuit into a low-power mode by disabling the receiver after the timing generator synchronizes the self-timing signal with the video synchronization signal; and switch the circuit out of the low-power mode by enabling the receiver so that the timing generator re-synchronizes the self-timing signal with the video synchronization signal.

Some embodiments relate to a method of synchronizing a shutter operation of shutter glasses with a video synchronization signal for displayed video. The shutter glasses can provide a wearer with a perception of viewing three dimensional video. The method is performed at the shutter glasses. In the method, the video synchronization signal is received. Period information is determined representing a period of the video synchronization signal. A self-timing signal is generated based on the period information. The shutter operation is controlled based on the self-timing signal.

Some embodiments relate to circuit for synchronizing a shutter operation of shutter glasses with a video synchronization signal for displayed video. The shutter glasses provide a wearer with a perception of viewing three dimensional video. The circuit includes a period information analyzer configured to analyze the video synchronization signal and determine period information representing a period of the video synchronization signal. The circuit also includes a self-timing counter configured to receive the period information and to generate a self-timing signal to control the shutter operation based on the period information.

Some embodiments relate to method of synchronizing a self-timing signal with a synchronization signal. In the method, the synchronization signal is received. A self-timing signal is generated that is synchronized with the synchronization signal. A circuit is controlled to enter a low-power mode of operation in which reception of the synchronization signal is disabled. The circuit is controlled to exit the low-power mode to enable reception of the synchronization signal. The self-timing signal is re-synchronized with the synchronization signal.

Some embodiments relate to a circuit for synchronizing a self-timing signal with a synchronization signal. The circuit includes a receiver configured to receive the synchronization signal. The circuit also includes a timing generator configured to generate a self-timing signal synchronized with the synchronization signal. The circuit further includes a controller configured to: switch the circuit into a low-power mode by disabling the receiver after the timing generator synchronizes the self-timing signal with the synchronization signal; and switch the circuit out of the low-power mode by enabling the receiver so that the timing generator re-synchronizes the self-timing signal with the synchronization signal.

### BRIEF DESCRIPTION OF THE DRAWINGS

FIG. 1 illustrates the principle behind viewing a 3D stereoscopic picture using shutter glasses;

FIG. 2 illustrates the emission characteristics of an infrared-emitting diode;

FIG. 3 illustrates the layout of a plurality of infrared-emitting diodes for covering the user viewing range;

FIG. 4 illustrates a suitable user viewing range for viewing a 3D stereoscopic picture;

FIG. 5 illustrates an exemplary configuration of a 3D stereoscopic picture viewing system to which a first embodiment of the present invention has been applied;

FIG. 6 illustrates a sync signal sent from a transmitting apparatus;

FIG. 7 illustrates the relationship between left/right picture display and a sync signal;

FIG. 8 is a block diagram illustrating an exemplary configuration of the shutter glasses shown in FIG. 5;

FIG. 9 explains the operation of a determining unit;

FIG. 10 explains the operation of a determining unit;

FIG. 11 explains a period count;

FIG. 12 explains a period count;

FIG. 13 explains a period count;

FIG. 14 explains the computation of period information;

FIG. 15 explains the computation of period information;

FIG. 16 explains the operation of a period information storage unit;

FIG. 17 explains the operation of a period information storage unit;

FIG. 18 explains the operation of a period information storage unit;

FIG. 19 explains the operation of a self-timing counter;

FIG. 20 explains the operation of a self-timing counter;

FIG. 21 explains the operation of a self-timing counter;

FIG. 22 explains the operation of a shutter driver and a shutter unit;

FIG. 23 illustrates exemplary temperature characteristics of a crystal oscillator;

FIG. 24 illustrates a sync signal and generated timing signals;

FIG. 25 is a flowchart explaining a timing signal generation process;

FIG. 26 is a flowchart explaining another timing signal generation process;

FIG. 27 illustrates another exemplary configuration of a period information storage unit;

FIG. 28 illustrates preset period information stored in the period information storage unit shown in FIG. 27;

FIG. 29 illustrates an exemplary configuration of a 3D stereoscopic picture viewing system to which a second embodiment of the present invention has been applied;

FIG. 30 illustrates an exemplary configuration of a 3D stereoscopic picture viewing system to which a third embodiment of the present invention has been applied; and

FIG. 31 illustrates an exemplary configuration of a 3D stereoscopic picture viewing system to which a fourth embodiment of the present invention has been applied.

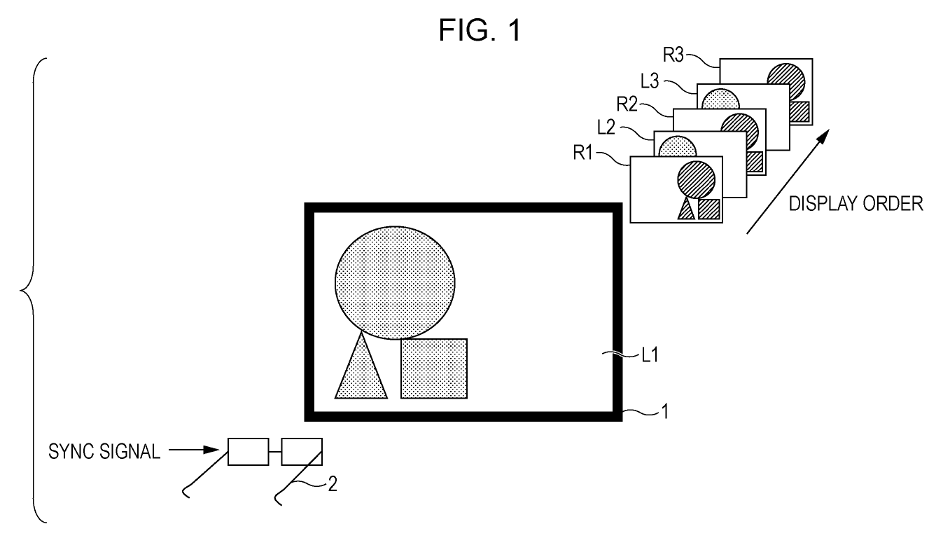

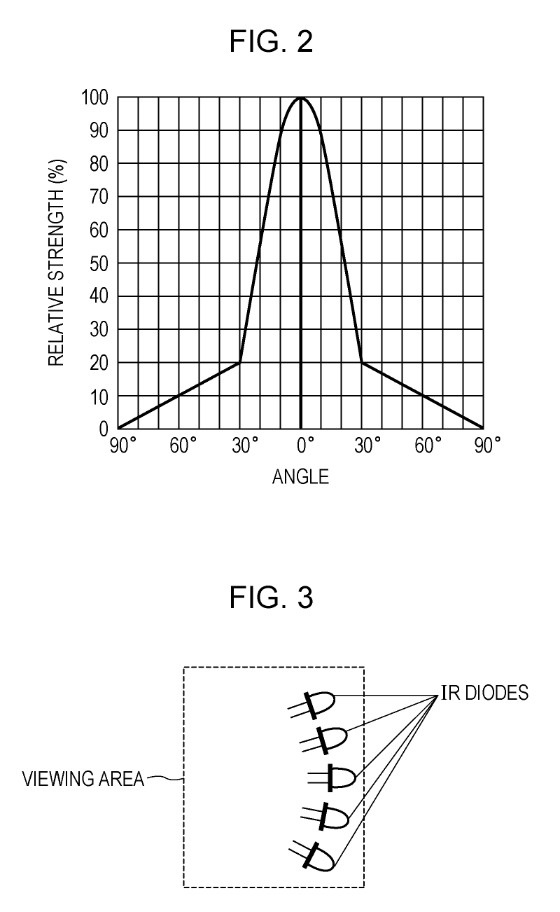

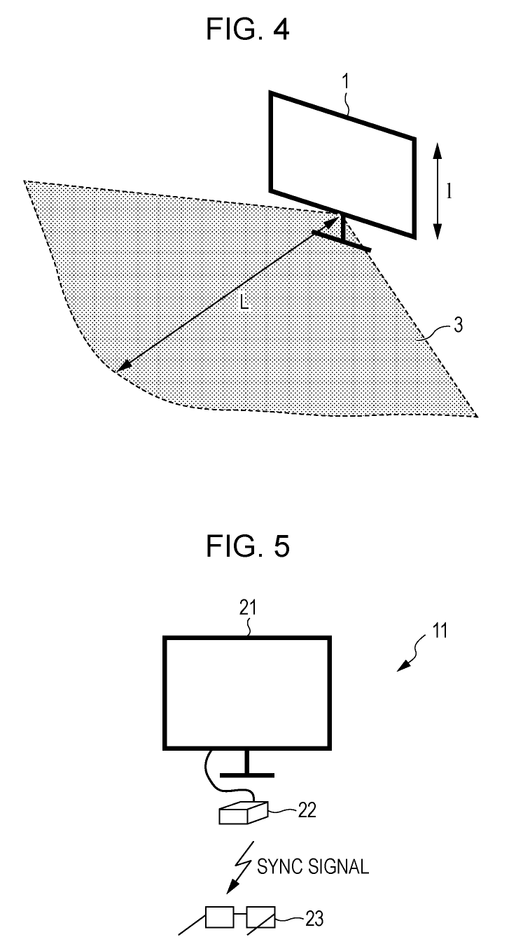

### DESCRIPTION OF THE PREFERRED EMBODIMENTS

### First Embodiment of the Present Invention

FIG. 5 illustrates an exemplary configuration of a 3D stereoscopic picture viewing system to which a first embodiment of the present invention has been applied.

In FIG. 5, the 3D stereoscopic picture viewing system 11 includes a television 21, a transmitting apparatus 22, and shutter glasses 23.

The television 21 receives externally-provided 3D stereoscopic content data (i.e., 3D stereoscopic picture data), and on the basis of that 3D stereoscopic picture data, displays 2D pictures that cause the user to perceive a 3D stereoscopic picture. More specifically, the television 21 is an LCD, PDP, or similar flat panel display that alternately displays left-eye and right-eye pictures having parallax. It should be appreciated that the format of the 3D stereoscopic picture data received by the television 21 is not particularly limited. The format of the received 3D stereoscopic picture data may be, for example, a format wherein a left-eye picture and a corresponding right-eye picture are stored as a set, or a format wherein a 2D picture and its depth information are stored as a set.

The transmitting apparatus 22 is connected to the television 21, and includes an infrared-emitting diode that outputs infrared light. The transmitting apparatus 22 uses infrared to transmit a sync signal to the shutter glasses 23. The sync signal is supplied to the transmitting apparatus 22 from the television 21, and is used for synchronization with the left-eye and right-eye pictures.

The shutter glasses 23 include functions for operating as a signal receiving apparatus. The shutter glasses 23 receive the sync signal transmitted from the transmitting apparatus 22 using infrared, and controls the liquid crystal devices on the basis of the received sync signal. By controlling the liquid crystal devices on the basis of the sync signal, only right-eye pictures are input into the user's right eye, and only left-eye pictures are input into the user's left eye. In so doing, the user wearing the shutter glasses 23 is able to perceive a 3D stereoscopic picture.

### Description of Sync Signal

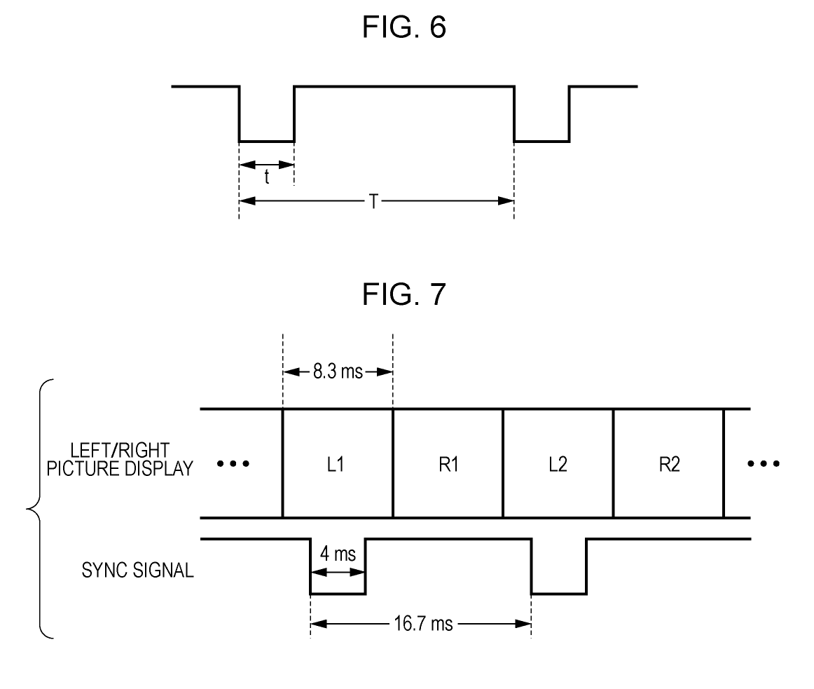

FIG. 6 illustrates a sync signal sent from the transmitting apparatus 22.

The sync signal is the vertical sync signal of a 2D picture displayed on the television 21. The sync signal is a pulse signal having a period T (ms), during which the signal is low for a time t (ms), and high otherwise. The television 21 displays left-eye pictures and right-eye pictures in alternation, and thus the sync signal is also a switching signal for switching between the left-eye and right-eye pictures.

Herein, in the present embodiment, 120 Hz is taken to be the framerate at which the television 21 displays 2D pictures (i.e., the display framerate). In this case, the left-eye and right-eye pictures are alternately displayed at an interval of approximately 8.3 ms, in the following order: left-eye picture L1, right-eye picture R1, left-eye picture L2, right-eye picture R2, and so on, as shown in FIG. 7. Additionally, the sync signal becomes a 60 Hz pulse signal, with each single period T being approximately 16.7 ms. The low (L) time t of the sync signal during each period is taken to be 4 ms.

### Exemplary Configuration of Shutter Glasses 23

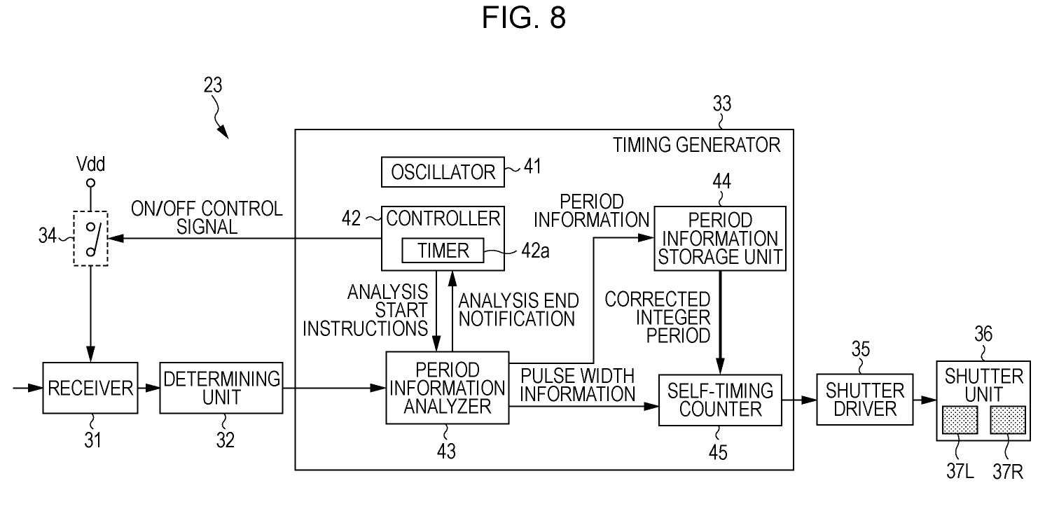

FIG. 8 is a block diagram illustrating an exemplary configuration of shutter glasses 23 that act as a signal receiving apparatus that receives a sync signal.

The shutter glasses 23 include a receiver 31, a determining unit 32, a timing generator 33, a switch 34, a shutter driver 35, and a shutter unit 36. In addition, the timing generator 33 includes an oscillator 41, a controller 42, a period information analyzer 43, a period information storage unit 44, and a self-timing counter 45.

The receiver 31 may be realized as an infrared communication module, for example. The receiver 31 receives a sync signal sent from the transmitting apparatus 22 using infrared, and supplies the received signal to the determining unit 32. The receiver 31 operates when supplied with a power source voltage Vdd via the switch 34. When supply of the power source voltage Vdd is cut off by the switch 34, the receiver 31 does not operate.

On the basis of the period T=16.7 ms and L time t=4 ms of the sync signal to be received, the determining unit 32 determines whether or not the received sync signal is valid. If it is determined that supplied sync signal is a valid sync signal, then the determining unit 32 supplies the supplied sync signal to the period information analyzer 43. In contrast, if it is determined that the supplied sync signal is not a valid sync signal, then the determining unit 32 does not supply the supplied sync signal to the period information analyzer 43. In so doing, the determining unit 32 functions as a noise filter, and is able to prevent downstream malfunction.

Herein, the determining unit 32 may acquire the period T=16.7 ms and L time t=4 ms of the sync signal from memory internal to the shutter glasses 23 (not shown), or ascertain the above values in advance by receiving information from the transmitting apparatus 22 using infrared communication.

The oscillator 41 of the timing generator 33 may be realized as a crystal oscillator, for example. The oscillator 41 generates a reference clock that acts as a reference for operation within the timing generator 33, and supplies reference clock information to the various internal components of the timing generator 33. In the present embodiment, the oscillator 41 is taken to generate a reference clock having a frequency of 1 MHz.

The controller 42 controls power supply to the receiver 31 by switching the switch 34 on or off. In addition, while the switch 34 is switched on, the controller 42 performs control that causes the period information analyzer 43 to analyze period information.

More specifically, the controller 42 supplies the switch 34 with an on/off control signal for switching on power supply to the receiver 31. Subsequently, the controller 42 supplies the period information analyzer 43 with analysis start instructions for starting analysis of period information. In response to the analysis start instructions, the controller 42 receives an analysis end notification from the period information analyzer 43, which indicates that analysis has ended. Upon acquiring this notification, the controller 42 supplies the switch 34 with an on/off control signal for switching off power supply to the receiver 31.

The controller 42 includes an internal timer 42a that measures a self-timing period after the analysis end notification is acquired from the period information analyzer 43. This self-timing period is the period of time during which the shutters of the shutter unit 36 are driven independently of the sync signal received from the transmitting apparatus 22, and is computed from the allowable error with respect to the sync signal received from the transmitting apparatus 22. A detailed method for computing the self-timing period will be described later.

Once the self-timing period as measured by the timer 42a has elapsed, the controller 42 again causes power supply to the receiver 31 to be switched on, and also causes the period information analyzer 43 to analyze period information.

In response to an on/off control signal from the controller 42, the switch 34 switches the supply of the power source voltage Vdd to the receiver 31 on or off.

On the basis of analysis start instructions from the controller 42, the period information analyzer 43 measures period information and pulse width information with respect to a sync signal supplied from the determining unit 32.

More specifically the period information analyzer 43 measures the period and pulse width of a sync signal supplied from the determining unit 32 by keeping a count on the basis of a reference clock. The period information analyzer 43 may be realized as a register (i.e., a flip-flop), for example. The period information analyzer 43 supplies the period-related measurement results to the period information storage unit 44 in the form of period information, while supplying the pulse width-related measurement results to the self-timing counter 45 in the form of pulse width information.

Herein, the period information analyzer 43 acquires the period information by measuring the average value of 128 periods. The period information expressing the result of averaging 128 periods thus contains an integer part and a fractional part. In this case, the period information analyzer 43 supplies the period information storage unit 44 with all information, including both the integer part and the fractional part.

Meanwhile, the period information analyzer 43 acquires the pulse width information by measuring the average value of the pulse width for four consecutive periods in the sync signal during the period measurement. The period information analyzer 43 then supplies the self-timing counter 45 with pulse width information containing just the integer part of the average value measurement result. This is because although the pulse width information determines the open time of the shutter unit 36, as described later, the open time is not as demanding as the period information in terms of precision.

By thus computing the period and the pulse width of the sync signal average values over multiple periods, and then supplying the results as period information and pulse width information, it becomes possible to absorb the following types of error: deviations in the oscillator in the transmitting apparatus 22 and the oscillator in the shutter glasses 23 (i.e., the oscillator 41); incoming signal fluctuations due to degraded communication quality; and time-based fluctuations in the output unit of the transmitting apparatus 22 as well as the receiver 31 of the shutter glasses 23.

Herein, since the pulse width information is not as demanding as the period information in terms of precision, the system may also be configured to adopt preset pulse width information, without computing pulse width information from a received sync signal. In other words, the measurement of the pulse width information may be omitted.

After measuring the period information and pulse width information, the period information analyzer 43 supplies an analysis end notification to the controller 42.

Meanwhile, since infrared communication is highly directional as described earlier, it is possible for phenomena such as flickering to occur in incoming signals from the transmitting apparatus 22. The period information analyzer 43 determines if there is flickering in an incoming signal. If there are single-pulse flickers over 128 periods, then the period and the pulse width can still be measured despite the flickering. In contrast, if the signal is discontinuous for two consecutive pulses, or if flickering occurs in the first period or the 128th period, then average value measurement becomes problematic, and thus measurement is restarted from the beginning.

The period information storage unit 44 converts the period information supplied from the period information analyzer 43 into a value usable by the self-timing counter 45, and supplies the result to the self-timing counter 45. More specifically, the period information storage unit 44 extracts just the integer part of the period information from among the integer part and the fractional part supplied from the period information analyzer 43, and then supplies just the integer part to the self-timing counter 45. However, if the period information storage unit 44 were to continuously supply the integer part of the value of the period information (i.e., the same integer value), then the discarded magnitude of the fractional part becomes error, which may become a large value when accumulated. For this reason, the period information storage unit 44 supplies the self-timing counter 45 with a corrected integer period obtained by converting the period information into an integer value that minimizes the error of the fractional part.

On the basis of the corrected integer period supplied from the period information storage unit 44 and the pulse width supplied from the period information analyzer 43 in the form of pulse width information, the self-timing counter 45 generates a timing signal identical to the sync signal sent by the transmitting apparatus 22. More specifically, the self-timing counter 45 generates a timing signal by switching high or low when the count according to a reference clock becomes a number that corresponds to the corrected integer period and the pulse width.

The generated timing signal is thus a signal for driving the right-eye shutter 37R and the left-eye shutter 37L of the shutter unit 36, but the right-eye shutter 37R and the left-eye shutter 37L should also be opened and closed in alternation. For this reason, in addition to generating the timing signal identical to the sync signal, the self-timing counter 45 also generates a timing signal that is 180° out of phase with the sync signal. The timing signal that is identical to the sync signal sent by the transmitting apparatus 22 is used as a right-eye timing signal for driving the right-eye shutter 37R, for example, while the 180° out-of-phase timing signal is used as a left-eye timing signal for driving the left-eye shutter 37L.

The controller 42, period information analyzer 43, period information storage unit 44, and self-timing counter 45 of the timing generator 33 may be realized by logic circuits or a microprocessor.

On the basis of the timing signals supplied from the self-timing counter 45, the shutter driver 35 generates applied voltages that are applied to the liquid crystal devices of the shutter unit 36.

The shutter unit 36 includes a right-eye shutter 37R and a left-eye shutter 37L. The right-eye shutter 37R and the left-eye shutter 37L are each realized by a liquid crystal device with diode terminals that operates when given an applied voltage on the order of 10 V to 20 V. In the present embodiment, both the right-eye shutter 37R and the left-eye shutter 37L are respectively opened when a potential difference of 0 V is applied by the shutter driver 35, and closed when a potential difference of ±15 V is applied.

In the shutter glasses 23 configured as described above, period information and pulse width information is generated on the basis of a received sync signal. Timing signals are then generated on the basis of the generated period information and pulse width information. The opening and closing of the right-eye shutter 37R and the left-eye shutter 37L of the shutter unit 36 are then controlled on the basis of generated timing signals. In other words, the shutter glasses 23 use the received sync signal as a basis for reproducing an identical timing signal, and then conducts shutter operations on the basis of the reproduced timing signal. Furthermore, the shutter glasses 23 cuts off power supply to the receiver 31 while conducting shutter operations on the basis of the self-generated timing signals. In so doing, reduced power consumption is realized, and the drive time by a battery power source can be increased, for example.

The operation of the various components of the shutter glasses 23 will now be described in detail.

### Operation of the Determining Unit 32

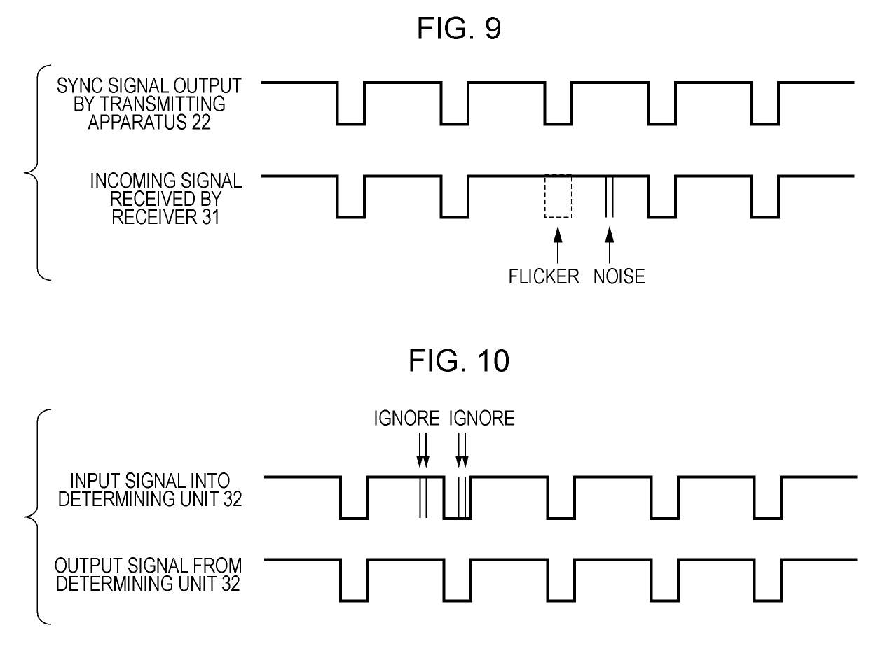

Operation of the determining unit 32 will now be described with reference to FIGS. 9 and 10.

FIG. 9 illustrates a sync signal output by the transmitting apparatus 22, and the signal incoming into the receiver 31 when receiving a signal corresponding to the sync signal.

Depending on the relative positions of the transmitting apparatus 22 and the receiver 31 of the shutter glasses 23, an infrared signal from the transmitting apparatus 22 might not be received at sufficient strength, and flickering may occur in the incoming signal, as shown in FIG. 9. Additionally, the receiver 31 may also pick up noise from other electronic equipment.

As described earlier, the determining unit 32 determines whether or not an incoming sync signal is valid on the basis of the period T=16.7 ms and L time t=4 ms of the sync signal that should be received. In other words, when change to high or low is seen in the signal at a time when no change should occur according to values of the period T and the L time t, the determining unit 32 ignores such change as the effects of noise or similar factors, and does not output to the period information analyzer 43. As a result, momentary signal changes occurring during the high or low periods are not produced in the output signal from the determining unit 32. In so doing, the determining unit 32 functions as a noise filter that eliminates noise, and is able to prevent downstream malfunction. Herein, missing pulses in the incoming signal due to flickering are not restored, and simply output to the downstream period information analyzer 43.

### Operation of the Period Information Analyzer 43

The operation of the period information analyzer 43 will now be described.

As described earlier, the period information analyzer 43 may be realized by a register, for example, and measures the period and pulse width of a sync signal supplied from the determining unit 32 on the basis of a reference clock. In addition, in order to eliminate errors and deviations, the period information analyzer 43 measures the period and the pulse width as average values taken over a plurality of periods.

### Description of Register Bit Lengths

First, register bit lengths in the period information analyzer 43 for suitably measuring the period as an average value of 128 periods will be described. Since 128 periods of a 60 Hz sync signal are to be measured with a 1 MHz reference clock, the count number can be computed using the following equation.

$$\begin{matrix}16.7 ms \times 128 periods / ( 1 / 1 MHz ) = 2133333 ( decimal ) \\ = 208 D 55 ( hexadecimal )\end{matrix}$$

In other words, given the count number 208D55 (hexadecimal), expressing each digit of 08D55 (hexadecimal) involves 4 bits, while expressing the leading digit 2 (hexadecimal) involves 2 bits. In other words, a register of length 5×4+2=22 bits is preferable.

Meanwhile, the bit length of a register used in measuring the pulse width as an average value over 4 periods becomes 14 bits, as given in the following equation.

$$\begin{matrix}4 ms \times 4 periods / ( 1 / 1 MHz ) = 16000 ( decimal ) \\ = 3 E80 ( hexadecimal / 14 bits )\end{matrix}$$

As described above, the period information analyzer 43 measures a period averaged over 128 periods and a pulse width averaged over 4 periods, using a 22-bit register for calculating the period, and a 14-bit register for calculating the pulse width.

### Description of Period Count

The period count by the period information analyzer 43 will now be described.

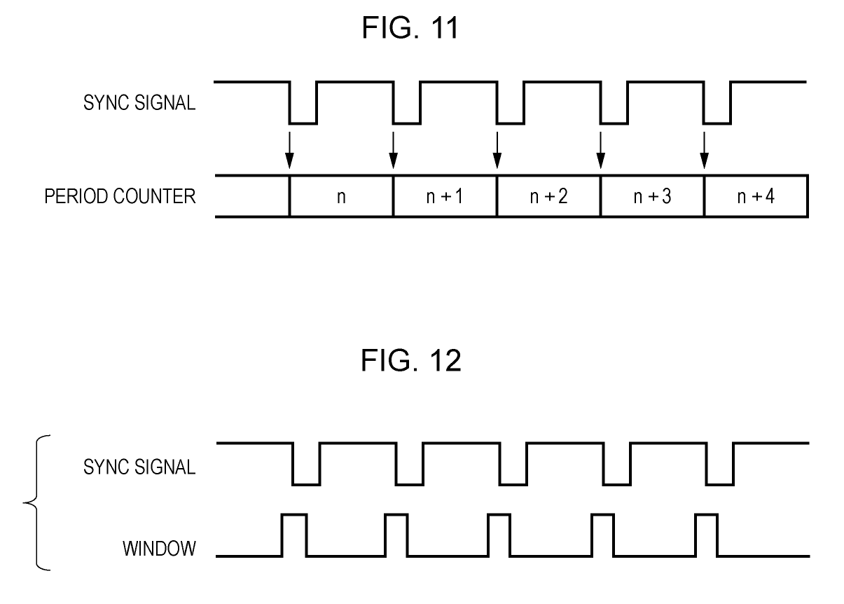

Assuming no flickering or noise occurs, the sync signal becomes a pulse having a fixed period T, as shown in FIG. 11. Consequently, the period information analyzer 43 detects each falling edge in the sync signal, and increments a counter that counts the number of periods.

More specifically, the period information analyzer 43 uses the reference clock to generate a window of width ±10% the period T and centered about each falling edge of the sync signal, as shown in FIG. 12. Upon detecting a falling edge of the sync signal within the window, the period information analyzer 43 increments the counter. In contrast, when a falling edge of the sync signal is not detected within the window, the period information analyzer 43 determines that a flicker occurred, and increments the counter at the end of the window.

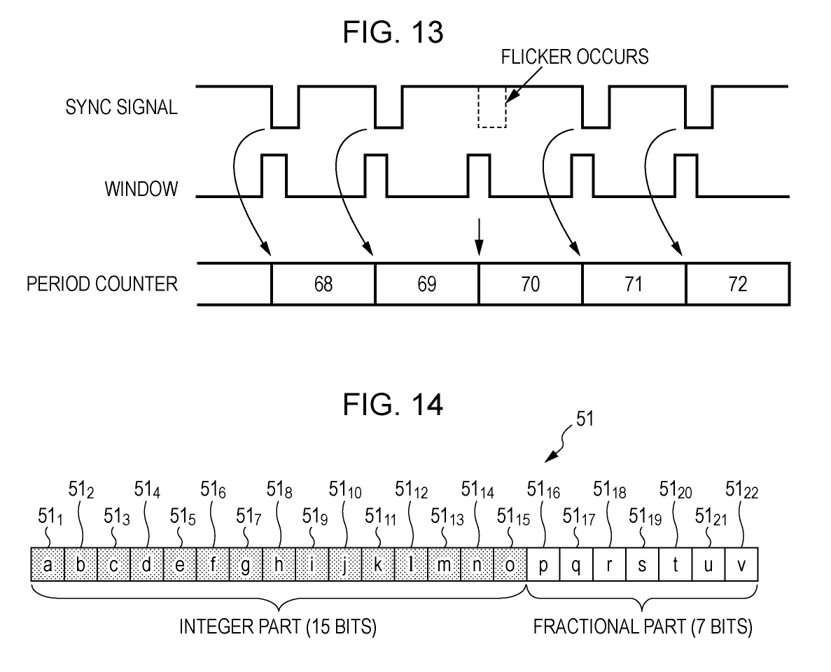

For example, assume that the pulse is lost due to a flicker during the 70th period while measuring the period count, as shown in FIG. 13. In this case, although the counter is incremented by 1 upon detecting the falling edge of the sync signal during the 68th, 69th, 71st, and 72nd periods, the counter is incremented by 1 at the end of the window during the 70th period.

In this way, when a flicker occurs in just one period while counting up to a predetermined period count (i.e., 128 periods), the period information analyzer 43 increments the counter (i.e., the period count) as though no flicker occurred.

In contrast, when a pulse does not appear within the window for two consecutive times (i.e., when a flicker lasts for two or more periods), the period information analyzer 43 determines that the communication quality has worsened beyond expectations, and restarts the period count from the beginning. Additionally, an accurate count becomes problematic when a flicker occur during the first period or the 128th period, because the start and end points become undetermined. Consequently, the period information analyzer 43 also restarts the period count from the beginning in the case where a falling edge is not detected within the window during the first period or the 128th period.

As described above, the period information analyzer 43 determines the presence or absence of flickering in the sync signal. If a single-pulse flicker occurs, then the period can be counted as long as the flicker occurs in a period other than the first period or the 128th period. If the period count succeeds, then the average value of the periods can be computed.

### Description of Period Averaging

Next, the computation of the average value of the period after counting 128 periods by using the count of a reference clock will be described.

The period information analyzer 43 computes the average value of the 128 periods by performing a 7-bit shift on the counted value in the register. In other words, in the 22-bit register, the upper 15 bits are allocated to the integer part, while the lower 7 bits are allocated to the fractional part. Since the period count 128 is a power of 2, the average value can be easily computed by performing a 7-bit shift if using a logic circuit. Conversely, the accumulated period count is taken to be 128, a power of 2, since doing so allows the average value to be easily computed.

FIG. 14 illustrates a 22-bit register 51 for calculation of the period by the period information analyzer 43.

In the 22-bit register 51, the upper 15 bits of the register from 51₁ to 51₁₅ are allocated to the integer part, while the lower 7 bits from 51₁₆ to 51₂₂ are allocated to the fractional part. In FIG. 14, the letters a to v represent the respective values (0 or 1) in the register from 51₁ to 51₁₅.

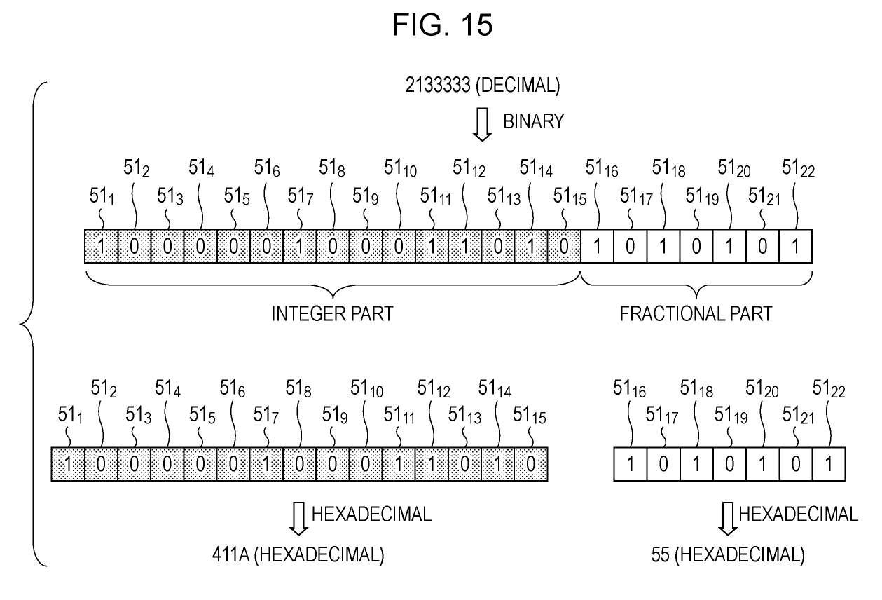

As described earlier, the count number when counting 128 periods becomes 2133333 (decimal)=208D55 (hexadecimal). When expressed in binary, 2133333 (decimal) becomes 1000001000110101010101 (binary). When the integer part and the fractional part expressed in binary are then respectively expressed in hexadecimal, the values become the following, as also shown in FIG. 15.

Integer part=411A (hexadecimal/15 bits)

Fractional part=55 (hexadecimal/7 bits)

The period information analyzer 43 supplies the 22-bit information, including both the integer part and the fractional part, to the period information storage unit 44 as period information.

### Description of Pulse Width Averaging

The computation of the average value of the pulse width will now be described.

While measuring the period of a sync signal, the period information analyzer 43 measures the pulse width of the signal for four consecutive periods by using a 14-bit register. If flickering or missing pulses occur in the incoming signal during the pulse width measurement, then the period information analyzer 43 resets the register, and restarts the count.

The period information analyzer 43 then computes the average value of the pulse width over four periods by performing a 2-bit shift on the counted value in the register. In other words, since the period count 4 is a power of 2, the average value of the pulse width can be easily computed by performing a 2-bit shift, similarly to computing the average period. In the 14-bit register, the upper 12 bits become the integer part, while the lower 2 bits become the fractional part. The period information analyzer 43 then supplies only the upper 12-bit integer part to the self-timing counter 45 as pulse width information.

When measuring a 4 ms pulse width with a 1 MHz reference clock, the count number becomes:

4 ms/(1/1 MHz)=4000 (decimal)

=FA0 (hexadecimal)

Assume, for example, that pulse width signals like the following are supplied as a sync signal during period measurement: F9F, FA0, missing, FA, FA1, FA2, FA1, FA0, FA1, . . . , FA2, . . . . Herein, “missing” indicates that a pulse was not observed due to flickering.

In this example, the period information analyzer 43 is taken to count the four consecutive pulse widths FA, FA1, FA2, and FA1 in the register immediately after the missing pulse. In this case, the pulse width information supplied to the self-timing counter 45 by the period information analyzer 43 is FA1, the average value of the four pulse widths.

Herein, when measuring the average pulse width over four periods, the period information analyzer 43 may also add a condition, such as “the dispersion among the various pulse widths is within ±4 clocks”, for example. The period information analyzer 43 may then measure the average value of counts that satisfy the stipulated condition. In so doing, a reliable pulse width measurement result can be obtained, even from a small sample size of four periods.

### Operation of Period Information Storage Unit 44

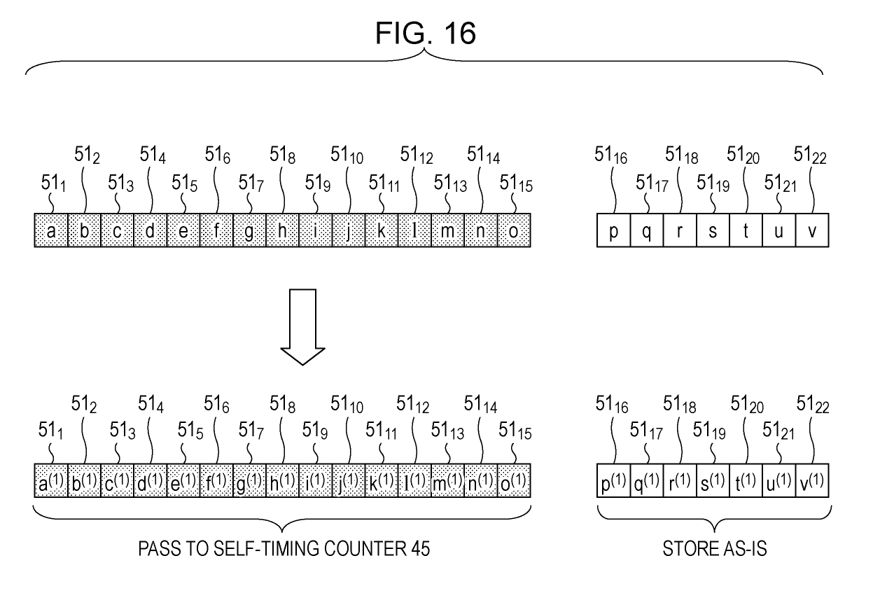

Operation of the period information storage unit 44 will now be described with reference to FIGS. 16 to 18.

The period information storage unit 44 takes the period information supplied from the period information analyzer 43, and from among the integer part and fractional part contained therein, supplies just the integer part countable by the self-timing counter 45 to the self-timing counter 45. However, if the integer part of the period information were to be continuously supplied from the period information analyzer 43, then the error with respect to the sync signal that is produced by the discarded magnitude of the fractional part would increase, and affect shutter operation.

Consequently, the period information storage unit 44 supplies the self-timing counter 45 with a corrected integer period that is adjusted for the error of the fractional part in the following way.

When the period information storage unit 44 supplies the corrected integer period to the self-timing counter 45 for the first time, the period information storage unit 44 passes the integer part of the period information supplied from the period information analyzer 43 (hereinafter referred to as the original integer part where appropriate) to the self-timing counter 45. As shown in FIG. 16, the original integer part is passed directly to the self-timing counter 45 as the first-round corrected integer period, with no changes to its value.

In addition, the period information storage unit 44 directly stores the fractional part of the period information supplied from the period information analyzer 43 (hereinafter referred to as the original fractional part where appropriate) as the first-round fractional part, with no changes to its value. In FIGS. 16 to 18, the values a to v in the register from 51₁ to 51₂₂ have attached numbers in parenthesis to the upper-right. Herein, the letters a to v represent the values after passing the corrected integer period for the nth time, where n is expressed by the numbers in parenthesis.

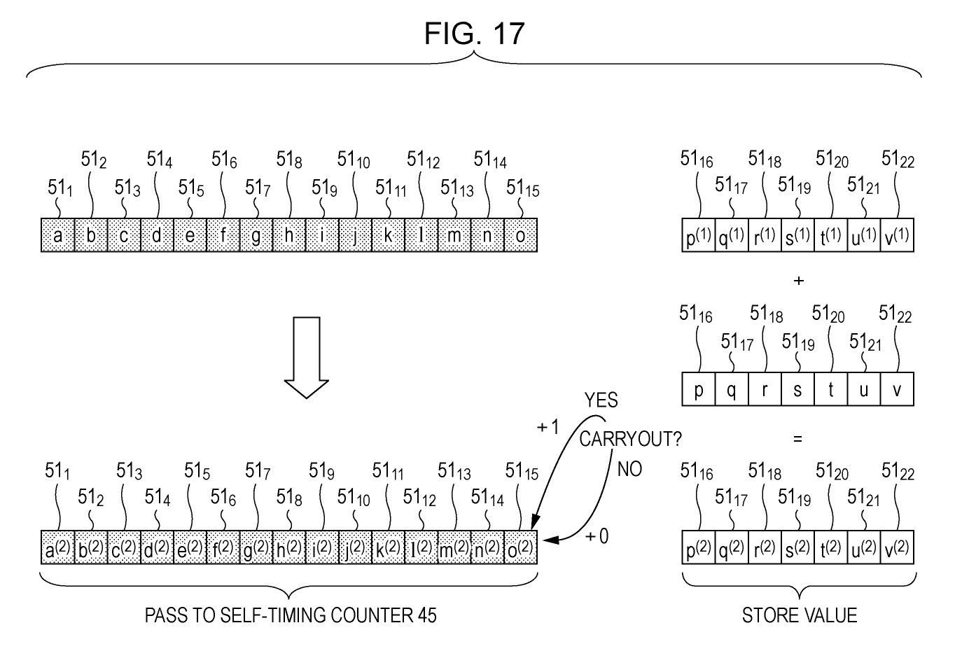

Subsequently, when supplying the corrected integer period for the second time, the period information storage unit 44 first adds the first-round fractional part that was stored above to the original fractional part, as shown in FIG. 17. The resulting sum of the first-round fractional part and the original fractional part is stored as the second-round fractional part.

If a carry-out is produced when adding the first-round fractional part to the original fractional part, then the period information storage unit 44 adds 1 to the original integer part, and passes the resulting value to the self-timing counter 45 as the second-round corrected integer period. In contrast, if a carry-out is not produced when adding the first-round fractional part to the original fractional part, then the period information storage unit 44 directly passes the original integer part to the self-timing counter 45 as the second-round corrected integer period, with no changes to its value.

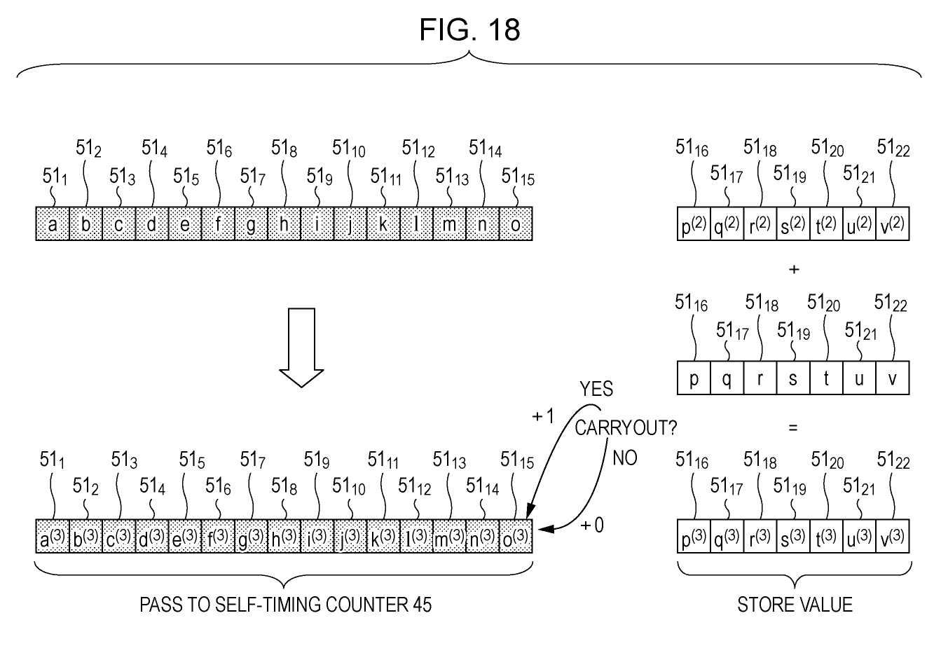

Subsequently, when supplying the corrected integer period for the third time, the period information storage unit 44 first adds the second-round fractional part that was stored above to the original fractional part, as shown in FIG. 18. The resulting sum of the second-round fractional part and the original fractional part is stored as the third-round fractional part.

If a carry-out is produced when adding the second-round fractional part to the original fractional part, then the period information storage unit 44 adds 1 to the original integer part, and passes the resulting value to the self-timing counter 45 as the third-round corrected integer period. In contrast, if a carry-out is not produced when adding the second-round fractional part to the original fractional part, then the period information storage unit 44 directly passes the original integer part to the self-timing counter 45 as the third-round corrected integer period, with no changes to its value.

Thereafter, a similar process is repeated for 128 periods (i.e., up to the 128th round).

Consequently, the corrected integer period supplied to the self-timing counter 45 from the period information storage unit 44 is one of the following values: value of the original integer part plus 1, or the value of the original integer part itself.

The fractional part is summed 128 times, but since the fractional part was originally a number divided by 128 (i.e., 7-bit shifted), the values p to v in the register 51₁₆ to 51₂₂ expressing the fractional part after summing 128 times become 0000000.

A description using specific numerical values will now be given.

Given the previous example, assume that in the period information supplied from the period information analyzer 43, the value of the original integer part is 411A (hexadecimal), and the value of the original fractional part is 55 (hexadecimal).

In this case, in the first round, the period information storage unit 44 directly passes the original integer part 411A (hexadecimal) to the self-timing counter 45 as the first-round corrected integer period.

<First Round>

First-round integer part (corrected integer period)=411A (hexadecimal/15 bits)

First-round fractional part=55 (hexadecimal/7 bits)

In the second round, the period information storage unit 44 adds the first-round fractional part 55 (hexadecimal/7 bits) to the original fractional part 55 (hexadecimal/7 bits). In other words, the period information storage unit 44 calculates the sum of 55 (hexadecimal/7 bits) and 55 (hexadecimal/7 bits).

The result of calculating the sum of 55 (hexadecimal/7 bits) and 55 (hexadecimal/7 bits) is 10101010 (binary/8 bits), and thus a carry-out is produced. Consequently, the period information storage unit 44 adds 1 to the original integer part 411A (hexadecimal) to yield 411B (hexadecimal), and passes this result to the self-timing counter 45 as the second-round corrected integer period. Additionally, the lower 7-bit portion 0101010 (binary/7 bits) of the above value 10101010 (binary/8 bits), or 2A (hexadecimal), is stored as the second-round fractional part.

<Second Round>

Second-round integer part (corrected integer period)=411B (hexadecimal/15 bits)

Second-round fractional part=2A (hexadecimal/7 bits)

In the third round, the period information storage unit 44 adds the second-round fractional part 2A (hexadecimal/7 bits) to the original fractional part 55 (hexadecimal/7 bits). In other words, the period information storage unit 44 calculates the sum of 2A (hexadecimal/7 bits) and 55 (hexadecimal/7 bits).

The result of calculating the sum of 2A (hexadecimal/7 bits) and 55 (hexadecimal/7 bits) is 7F (hexadecimal/7 bits), and thus a carry-out is not produced. Consequently, the period information storage unit 44 directly passes the original integer part 411A (hexadecimal) to the self-timing counter 45 as the third-round corrected integer period. Additionally, the above value 7F (hexadecimal) is stored as the third-round fractional part.

<Third Round>

Third-round integer part (corrected integer period)=411A (hexadecimal/15 bits)

Third-round fractional part=7F (hexadecimal/7 bits)

Thereafter, a similar process is repeated up to the 128th round.

If no new period information is supplied from the period information analyzer 43 after passing the 128th-round corrected integer period, then the period information storage unit 44 repeats the above process from the first round to the 128th round using the currently-stored period information.

### Operation of Self-Timing Counter 45

Operation of the self-timing counter 45 will now be described.

The self-timing counter 45 receives the corrected integer period supplied from the period information storage unit 44, and a pulse width supplied from the period information analyzer 43 as the pulse width information. On the basis of the above information, the self-timing counter 45 generates timing signals for driving the right-eye shutter 37R and the left-eye shutter 37L of the shutter unit 36. By generating signals on the basis of the corrected integer period and the pulse width, the self-timing counter 45 reproduces a timing signal identical to the sync signal, even when noise or missing pulses occur in the incoming sync signal.

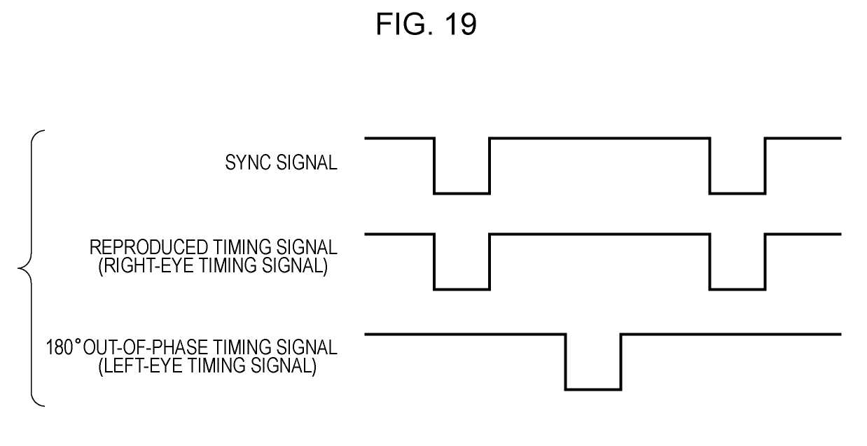

FIG. 19 illustrates a sync signal output by the transmitting apparatus 22, and timing signals generated (i.e., reproduced) by the self-timing counter 45.

The self-timing counter 45 generates a timing signal that is in phase with the sync signal, as well as a timing signal that is 180° out of phase with the sync signal. In the present embodiment, the timing signal that is in phase with the sync signal is used as the right-eye timing signal, while the timing signal that is 180° out of phase with the sync signal is used as the left-eye timing signal.

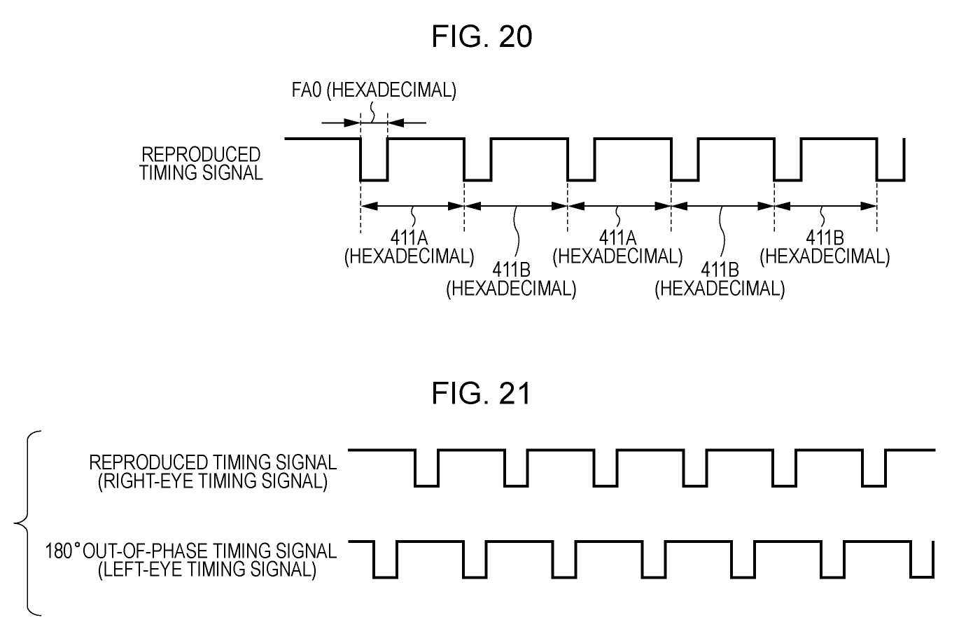

For example, given the above exemplary numerical values, the corrected integer periods 411A, 411B, 411A, 411B, 411B, . . . , are passed to the self-timing counter 45 from the period information storage unit 44. Additionally, pulse width information expressing the value FA0 (hexadecimal/12 bits) is supplied from the period information analyzer 43. In this case, the timing signal generated (i.e., reproduced) by the self-timing counter 45 is like that shown in FIG. 20.

The self-timing counter 45 uses the timing signal that is in phase with the sync signal and shown in FIG. 20 as the right-eye timing signal. In addition, the self-timing counter 45 generates a timing signal that is 180° out of phase with the right-eye timing signal, as shown in FIG. 21. This out of phase signal is used as the left-eye timing signal.

### Operation of Shutter Driver 35 and Shutter Unit 36

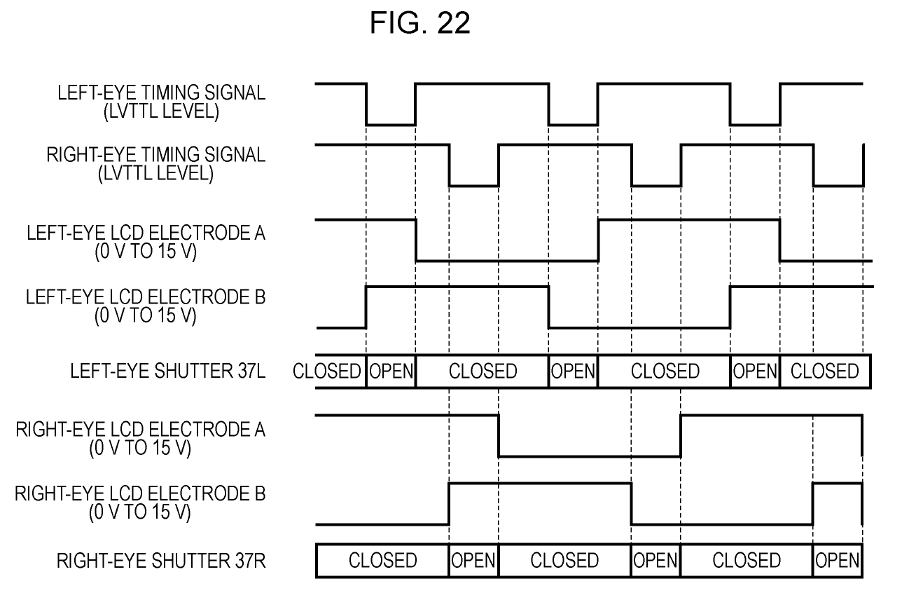

Operation of the shutter driver 35 and the shutter unit 36 will now be described with reference to FIG. 22.

A right-eye timing signal and a corresponding 180° out-of-phase left-eye timing signal like those shown in FIG. 22 are supplied from the self-timing counter 45 to the shutter driver 35. Herein, the right-eye timing signal and the left-eye timing signal are LVTTL level signals.

On the basis of the left-eye timing signal, the shutter driver 35 controls the voltage applied to an electrode A and its opposing electrode B in the left-eye liquid crystal device. In other words, for the electrode A of the left-eye liquid crystal device, the shutter driver 35 repeats a control wherein the electrode is set to the low potential (0 V) at the rising edge of the left-eye timing signal, and then returned to the high potential (15 V) at the next rising edge. In addition, for the electrode B of the left-eye liquid crystal device, the shutter driver 35 repeats a control wherein the electrode is set to the high potential (15 V) at the falling edge of the left-eye timing signal, and then returned to the low potential (0 V) at the next falling edge.

The liquid crystal device that realizes the left-eye shutter 37L opens when a potential difference of 0 V is applied, and closes when a potential difference of ±15 V is applied. Thus, the left-eye shutter 37L repeatedly opens and closes, as shown in FIG. 22. The pulse width of the left-eye timing signal corresponds to the open time of the left-eye shutter 37L.

Similarly, on the basis of the right-eye timing signal, the shutter driver 35 controls the voltage applied to an electrode A and its opposing electrode B in the right-eye liquid crystal device. In other words, for the electrode A of the right-eye liquid crystal device, the shutter driver 35 repeats a control wherein the electrode is set to the low potential (0 V) at the rising edge of the right-eye timing signal, and then returned to the high potential (15 V) at the next rising edge. In addition, for the electrode B of the right-eye liquid crystal device, the shutter driver 35 repeats a control wherein the electrode is set to the high potential (15 V) at the falling edge of the right-eye timing signal, and then returned to the low potential (0 V) at the next falling edge.

The liquid crystal device that realizes the right-eye shutter 37R opens when a potential difference of 0 V is applied, and closes when a potential difference of ±15 V is applied. Thus, the right-eye shutter 37R repeatedly opens and closes, as shown in FIG. 22. The pulse width of the right-eye timing signal corresponds to the open time of the right-eye shutter 37R.

In the closed state for both the left-eye shutter 37L and the right-eye shutter 37R, the polarity between the electrodes A and B is reversed in alternation in order to prevent burn-in of the liquid crystal devices.

### Computation of Self-Timing Period by Timer 42a

The self-timing period set by the timer 42a in the controller 42 will now be described.

The self-timing period set by the timer 42a is the period during which power supply to the receiver 31 is suspended, and thus it is desirable for the self-timing period to be as long as possible in order to maximize power savings. Consequently, the self-timing period may be taken to be the maximum length of time lasting until a threshold at which the allowable error range is exceeded for the error with respect to the sync signal, the above error being produced when generating a timing signal that is independent of the sync signal sent from the transmitting apparatus 22.

Thus, the time until such error exceeds the allowable range in the above circumstances is measured.

First, consider the error produced when generating a timing signal that is independent of the sync signal sent from the transmitting apparatus 22. The sync signal output by the transmitting apparatus 22 and the 1 MHz reference clock generated within the shutter glasses 23 are asynchronous. For this reason, conceivable factors contributing to the timing signal error include: (1) frequency deviation in the oscillator for generating a vsync signal at the transmitting apparatus 22 (i.e., the crystal oscillator) and the oscillator 41 in the shutter glasses 23; and (2) ±1 clock error when measuring with the reference clock.

The first factor, (1) frequency deviation in the oscillator for generating a vsync signal in the transmitting apparatus 22 and the oscillator 41 in the shutter glasses 23, will now be described.

The lineup of typical crystal oscillators currently available includes oscillators with frequency deviations of not more than ±20 ppm, not more than ±50 ppm, and not more than ±100 ppm, for example. Herein, assume that the respective crystal oscillators at the transmitting apparatus 22 and the oscillator 41 each have a frequency deviation of ±50 ppm. When the frequency deviation for both oscillators is taken together, a maximum deviation of 100 ppm is possible.

However, as described earlier, since the shutter glasses 23 measure the period of the sync signal by means of an internally-produced reference clock, fluctuations in the deviation of the crystal oscillator can be absorbed. Consequently, the combined frequency deviation for both oscillators can be safely ignored.

However, crystal oscillators also produce deviations due to temperature variation. Since the crystal oscillator that generates the reference clock is also susceptible, such deviation induced by temperature variation should be taken into account.

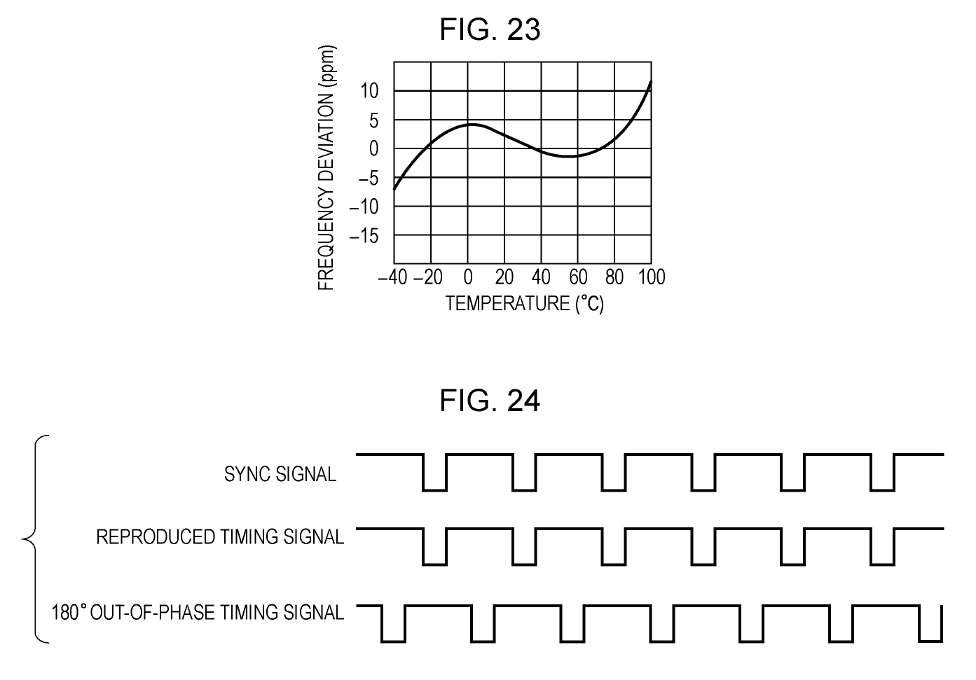

FIG. 23 illustrates exemplary temperature characteristics of a crystal oscillator. Note, however, that the temperature characteristics differ according to how the crystal oscillator is driven.

In the FIG. 23, the frequency deviation is shown for a broad range of temperature conditions from 0° C. to 70° C. However, under the conditions in which the shutter glasses 23 are to be used, it is unlikely that the temperature will change over the full range from 0° C. to 70° C. Consequently, the range of temperature variation can be restricted to that of the conditions under which the shutter glasses 23 are to be used.

Since consideration of the temperature change during the self-timing period can be restricted to that of the conditions under which the shutter glasses 23 are to be used, it is sufficient to consider a 20° C. variation, for example. According to the temperature characteristics shown in FIG. 23, a 20° C. temperature variation can produce a deviation (i.e., error) of 5 ppm.

The second factor, (2) ±1 clock error when measuring with the reference clock, will now be described.

The error produced when measuring a sync signal over 128 periods (=(1/60 Hz)×128=2.1 s) with a 1 MHz reference clock can be calculated as

(1/1 MHz)/(2.1 s)×10⁶=0.48 ppm

thus giving a potential error of 0.48 ppm.

Given the above factors, it is possible for a total error of 5 ppm+0.48 ppm=5.48 ppm to be produced.

Thus, the time until the error becomes 5.48 ppm is measured.

At the beginning of the self-timing period, the sync signal output by the transmitting apparatus 22 and the timing signal generated by the timing generator 33 are in phase, as shown in FIG. 24. Once the self-timing period starts, it is assumed that the signals gradually go out of phase. Additionally, it is assumed that allowable range of phase misalignment is ±10% of the 4 ms pulse width. This allowable range of phase misalignment is a value giving a sufficient margin for the switching timing between the left and right pictures.

An error of 5.48 ppm corresponds to a phase misalignment of

16.7 ms×5.48 ppm=0.092 μs

per period of the sync signal.

Since the allowable range of phase misalignment is ±10% of the 4 ms pulse width, when converted into time the allowable range becomes

4 ms×10%=400 μs

Consequently, the above gives

400 μs/0.092 μs=4347 periods

or in other words, the phase misalignment remains within the allowable range until 4347 periods have elapsed.

Since a single period is 16.7 ms (at 60 Hz),

4347 periods×16.7 ms=72.6 s

is the amount of the time equal to 4347 periods.

The above thus demonstrates that 72.6 s of self-timing operation is possible without exceeding the allowable range of phase misalignment. Therefore, this value is taken to be the value set as the self-timing period by the timer 42a of the controller 42.

### Ratio of Powered-On Time

Next, the ratio of time during which power supply to the receiver 31 is suspended in the shutter glasses 23 will be calculated.

Since the receiver 31 is powered on while measuring the period information and the pulse width information, the powered-on time is equal to 128 periods. In other words, the powered-on time equals 16.7 ms×128=2.13 s. In addition, 100 ms is a generous estimate for the time lag between the controller 42 performing a power-on or power-off control and actually powering on or off. Thus, the total powered-on time is 2.13 s+200 ms=2.33 s.

Since the self-timing period is 72.6 s, the ratio of powered-on time becomes

2.33 s/(2.33 s+72.6 s)=3.1%

The above thus demonstrates that the ratio of time during which the receiver 31 is powered on is merely 3.1%. Consequently, the shutter glasses 23 can contribute to lowered power consumption.

If measurement is repeatedly conducted using 72.6 self-timing periods and 2.33 s powered-on times, the shutter glasses 23 can operate with a continuous 3.1% ratio of powered-on time.

### Timing Signal Generation Process

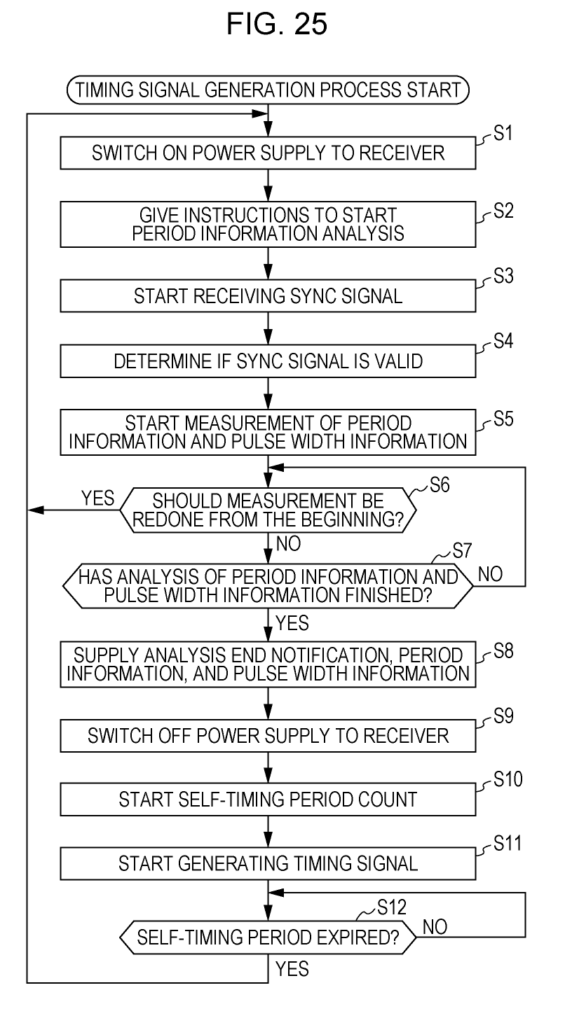

A timing signal generation process executed in the shutter glasses 23 will now be described with reference to the flowchart shown in FIG. 25. This process is initiated as a result of the user operating a start button (not shown) or similar element that instructs the shutter glasses 23 to begin operation.

First, in step S1, the controller 42 supplies the switch 34 with an on/off control signal causing power supply to the receiver 31 to be switched on. In step S2, the controller 42 supplies the period information analyzer 43 with analysis start instructions for starting the analysis of period information. The processing in steps S1 and S2 is executed simultaneously.

In step S3, the receiver 31 begins receiving a sync signal sent from the transmitting apparatus 22 by infrared. In step S4, the determining unit 32 determines whether or not the sync signal supplied from the receiver 31 is valid, with only signals determined to be valid sync signals being output downstream. In so doing, the determining unit 32 functions as a noise filter that eliminates noise in the sync signal.

In step S5, on the basis of the analysis start instructions from the controller 42, the period information analyzer 43 starts measuring the period information and the pulse width information of the sync signal. In order to eliminate errors and deviations, the period information analyzer 43 measures the period information of the sync signal as the average period over 128 periods, and measures the pulse width information as the average pulse width over 4 periods. Herein, the processing in steps S3 to S5 are also executed near-simultaneously.

In step S6, the period information analyzer 43 determines whether or not to restart measurement of the period information and the pulse width information of the sync signal. More specifically, since measuring the average value of the period information becomes problematic when the signal is discontinuous for two consecutive pulses or when flickering occurs in the first period or the 128th period, measurement should be restarted from the beginning if any of the above occur. Consequently, in step S6, the period information analyzer 43 determines whether or not the signal was discontinuous for two consecutive pulses, and whether or not flickering occurred in the first period or the 128th period.

If it is determined in step S6 that measurement should be restarted, then the process returns to step S1, and execution of the processing described above is repeated. In other words, analysis start instructions are again supplied to the period information analyzer 43, and measurement of the period information and the pulse width information is restarted.

In contrast, if it is determined in step S6 that measurement can continue without restarting, then the process proceeds to step S7, and the period information analyzer 43 determines whether or not analysis of the period information and the pulse width information has finished.

If it is determined in step S7 that analysis of the period information and the pulse width information has not finished, then the process returns to step S6, and the processing in step S6 and thereafter is repeated.

In contrast, if it is determined in step S7 that analysis of the period information and the pulse width information has finished, then the process proceeds to step S8, and the period information analyzer 43 supplies an analysis end notification, period information, and pulse width information. In other words, the period information analyzer 43 supplies an analysis end notification to the controller 42, period information to the period information storage unit 44, and pulse width information to the self-timing counter 45.

Upon being supplied with the analysis end notification, in step S9 the controller 42 supplies the switch 34 with an on/off control signal causing power supply to the receiver 31 to be switched off. In addition, in step S10, the timer 42a starts a count of the self-timing period.

In step S11, the period information storage unit 44 and the self-timing counter 45 begin generating timing signals. In other words, the period information storage unit 44 supplies the self-timing counter 45 with a corrected integer period obtained by converting the integer part of the period information into an integer value that minimizes the error of the fractional part. The self-timing counter 45 then generates timing signals on the basis of the corrected integer period supplied from the period information storage unit 44 and a pulse width supplied as the pulse width information from the period information analyzer 43. At this point, two timing signals are generated: a right-eye timing signal for the right-eye shutter 37R, and a 180° out-of-phase left-eye timing signal for the left-eye shutter 37L.

In step S12, the controller 42 determines whether or not the self-timing period has elapsed on the basis of the count value of the timer 42a. The controller 42 repeats the processing in step S12 until it is determined that the self-timing period has elapsed. During this time, the timing signal generation started in step S11 is continually executed.

If it is determined in step S12 that the self-timing period has elapsed, then the process returns to step S1. In so doing, the processing in the above steps S1 to S12 is executed again.

As a result, the 2.33 s powered-on time and 72.6 s powered-off time (i.e., self-timing period) as described earlier are repeated, and power is supplied to the receiver 31 for only 3.1% of the total operating time of the shutter glasses 23. Consequently, a long powered-off time (i.e., self-timing period) can be secured as compared to the related art, and power consumption can be reduced.

### Modification of Timing Signal Generation Process

The timing signal generation process described above is an example wherein the measurement of the period information and the pulse width information is repeatedly conducted. However, if an error of 5.48 ppm is allowable, then it is possible to simply conduct a phase entrainment process (i.e., a phase synchronization process) after having generating the timing signals once, without re-measuring average values over 128 periods. In so doing, the powered-on time can be further decreased.

For example, assuming that phase entrainment can be completed in five periods, then the amount of time that the receiver 31 is powered on can be calculated as

(16.7 ms×5 periods)+200 ms=283.5 ms

In this case, the above powered-on time becomes

283.5 ms/(283.5 ms+72.6 s)=0.39%

of the total operating time of the shutter glasses 23.

In other words, by configuring an embodiment to conduct phase entrainment in the second iteration of the process and thereafter, the ratio of powered-on time can be further reduced. Doing so further contributes to lowered power consumption.

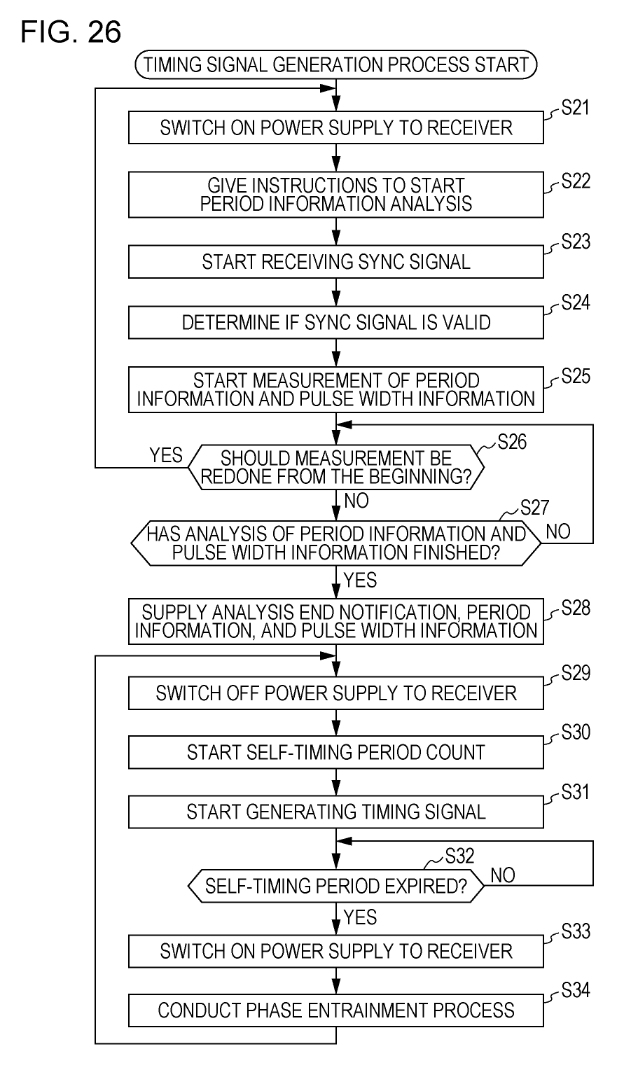

A timing signal generation process will now be described with reference to the flowchart shown in FIG. 26. In this process, phase entrainment is conducted after measuring the period information and the pulse width information and then generating timing signals once. As a result, the ratio of powered-on time is further decreased in the following process.

The processing in steps S21 to S32 of FIG. 26 is respectively similar to that in steps S1 to S12 of FIG. 25, and thus further description thereof is omitted.

However, in the timing signal generation process shown in FIG. 26, if it is determined in step S32 that the self-timing period has elapsed, then in step S33 the controller 42 supplies the switch 34 with an on/off control signal causing power supply to the receiver 31 to be switched on. In so doing, the receiver 31 begins receiving sync signals, and sync signals determined to be valid by the determining unit 32 are then supplied to the timing generator 33, as described with reference to FIG. 25.

Subsequently, in step S34, the timing generator 33 conducts phase entrainment to synchronize the phases of the sync signal and the timing signal. After phase entrainment is completed, the process returns to step S29, and the processing in steps S29 to S34 is repeated.

The phase entrainment processing herein may be conducted by the self-timing counter 45, or a separate phase entrainment unit configured to conduct phase entrainment processing may be provided in the timing generator 33. If phase entrainment is conducted by the self-timing counter 45, then the sync signal supplied from the determining unit 32 is also supplied to the self-timing counter 45.

As described above, according to the timing signal generation process in FIG. 26, the ratio of powered-on time can be reduced to 0.39% after the 128th period, thereby further contributing to lowered power consumption.

According to the shutter glasses 23 described above, a determining unit 32 eliminates noise, and a period information analyzer 43 measures the period and pulse width of a waveform restored from a signal determined to contain flickering. In so doing, period information can be obtained from the transmitting apparatus 22, even under conditions of poor communication quality between the transmitting apparatus 22 and the shutter glasses 23.

Furthermore, since the period information analyzer 43 measures the period and pulse width of the sync signal as average values taken over a plurality of periods, deviations in the oscillators in the transmitting apparatus 22 and the shutter glasses 23, incoming signal fluctuations due to degraded communication quality, and time-based fluctuations in the output unit of the transmitting apparatus 22 as well as the receiver 31 of the shutter glasses 23 can all be absorbed. As a result, an inexpensive crystal oscillator can be implemented as the oscillator 41.

The self-timing counter 45 generates timing signals on the basis of a corrected integer period supplied from the period information storage unit 44, as well as a pulse width supplied from the period information analyzer 43 as the pulse width information. Such timing signal generation can be realized with an extremely small-scale logic circuit, and devices such as a small-scale application-specific integrated circuit (ASIC), an inexpensive field-programmable gate array (FPGA), or a complex programmable logic device (CPLD) may be implemented.

Also, as described earlier, since the ratio of powered-on time of the receiver 31 can be made extremely small, the ratio of time wherein a sync signal is not received from the transmitting apparatus 22 increases, and thus the embodiment is less susceptible to the effects of poor communication quality.

From the above advantages, the shutter glasses 23 are able to perform shutter operations more reliably than shutter glasses of the related art, even under conditions of poor communication quality, such as when flickering occurs in the sync signal received in the user viewing range.

It should be appreciated that, in practice, the frequency of the sync signal sent from the transmitting apparatus 22 is limited to several values, such as 50 Hz, 59.94 Hz, and 60 Hz, for example. Consequently, it is possible to store in advance the period information of a sync signal that is expected to be received, in the form of preset period information. Then, instead of using the period information itself that is measured from the incoming signal, preset period information corresponding to the measured period information may be selected from among a plurality of preset period information stored in advance. A corrected integer period may then be generated from the selected preset period information and supplied for timing signal generation.

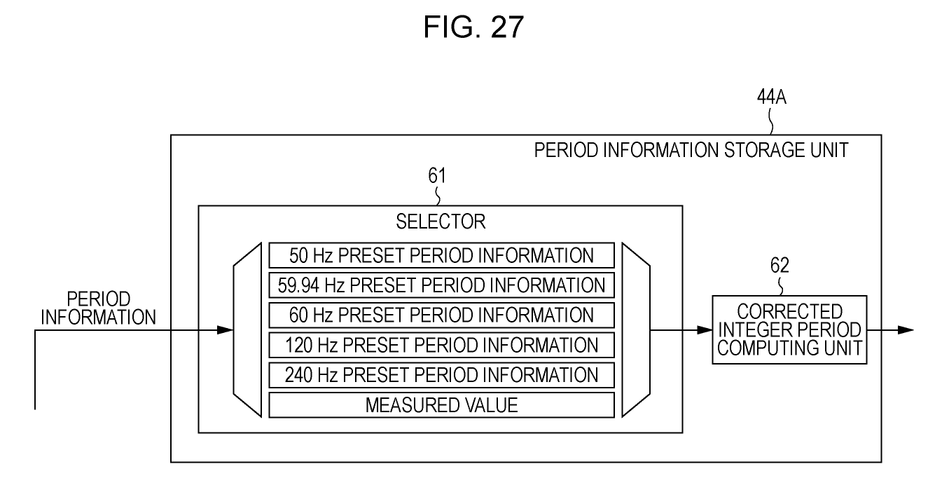

FIG. 27 is a block diagram illustrating the configuration of a period information storage unit 44A in the case where preset period information stored in advance is used to supply the corrected integer period.

The period information storage unit 44A includes a selector 61 and a corrected integer period computing unit 62.

The selector 61 stores a plurality of preset period information in advance. More specifically, the selector 61 stores 50 Hz, 59.94 Hz, 60 Hz, 120 Hz, and 240 Hz preset period information. The preset period information similarly contains a 15-bit integer part and a 7-bit fractional part. From the plurality of preset period information, the selector 61 selects the preset period information that is closest to the period information supplied from the period information analyzer 43, and then supplies the selected information to the corrected integer period computing unit 62.

Herein, the selector 61 may also select a “measured value” option. When “measured value” is selected, the period information supplied from the period information analyzer 43 is directly supplied to the corrected integer period computing unit 62. In this case, the period information storage unit 44A conducts the same processing as the period information storage unit 44 described earlier.

Similarly to the period information storage unit 44 described earlier, the corrected integer period computing unit 62 computes a corrected integer period by converting the preset period information supplied from the selector 61 into an integer value that minimizes the error of the fractional part, and then supplies the corrected integer period to the self-timing counter 45.

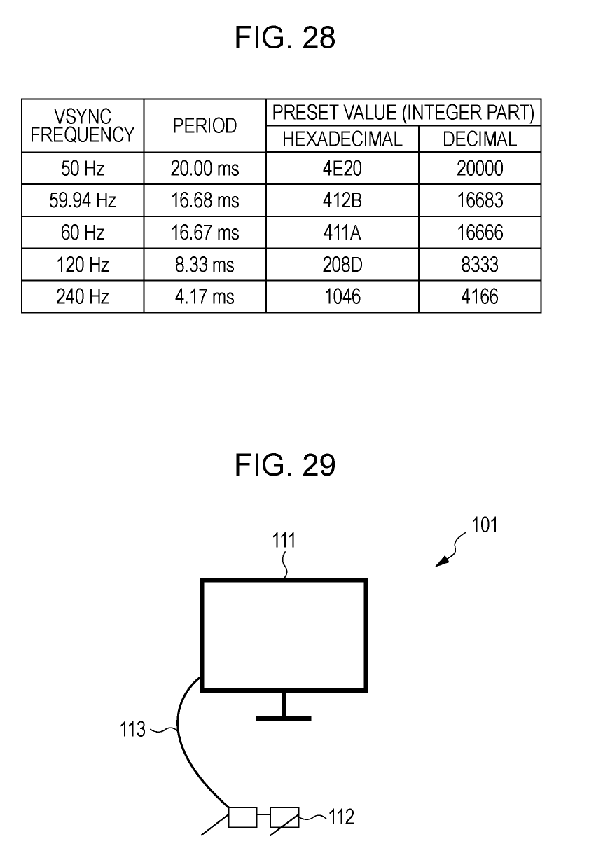

FIG. 28 illustrates exemplary integer parts for various preset period information stored in advance by the selector 61.

The selector 61 stores the value 4E20 (hexadecimal) as the integer part of preset period information corresponding to a 50 Hz vsync frequency. In addition, the selector 61 stores the value 412B (hexadecimal) as the integer part of preset period information corresponding to a 59.94 Hz vsync frequency. Similarly, the selector 61 stores the values 411A (hexadecimal), 208D (hexadecimal), and 1046 (hexadecimal) as the integer parts of preset period information corresponding to 60 Hz, 120 Hz, and 240 Hz vsync frequencies, respectively.

Although not shown in FIG. 28, the selector 61 similarly stores the fractional parts of preset period information corresponding to 50 Hz, 59.94 Hz, 60 Hz, 120 Hz, and 240 Hz vsync frequencies.

The self-timing period set by the timer 42a will now be calculated for the case of generating timing signals using preset period information.

Assume that crystal oscillators each having a frequency deviation of ±20 ppm are implemented as the oscillator at the transmitting apparatus 22 and the oscillator 41. In this case, when the frequency deviation for both oscillators is taken together, a maximum deviation of 40 ppm is possible. In addition, assume that the allowable range of phase misalignment is 400 μs, similar to the foregoing embodiment.

Given the above assumptions, the misalignment per period of the timing signal becomes

16.7 ms×40 ppm=0.668 μs

Consequently, the time until reaching the 400 μs limit of the allowable range of phase alignment is

400 μs/0.668 μs=598 periods

598 periods×16.7 ms=9.9 s

The above thus demonstrates that 9.9 s of self-timing operation is possible, and that 9.9 s can be set in the timer 42a.

Since the frequency deviation for both oscillators is taken into account, the self-timing period becomes shorter than that of the case when actually measured period information is used directly. However, the ratio of the powered-on time of the receiver 31 can still be significantly decreased compared to the related art.

### Other Embodiments

An embodiment of the present invention is not limited to the foregoing embodiments, and various changes are possible without departing from the scope and spirit of the present invention.

For example, in the foregoing embodiments, the transmitting apparatus 22 and the shutter glasses 23 communicate over infrared, but communication using radio-frequency waves is also possible. In the case where radio is implemented for communication between the transmitting apparatus 22 and the shutter glasses 23, the adopted frequency band may be the 300 MHz band used for keyless entry of automobiles, for example, or the 2.4 GHz band used for cordless phones and similar devices.

As described earlier, since communication by infrared is highly directional, potential worsening of communication quality is a concern. In contrast, communication by radio, while partially dependent on antenna shape, has a wider communication range than infrared, and thus communication quality can be improved. On the other hand, communication by radio has the drawback of being inferior to infrared in terms of power consumption. However, since the ratio of powered-on time is low, as described earlier, the shutter glasses 23 can still be used for long periods of time when radio-wave communication is used. Stated differently, by conducting the timing signal generation process described earlier, it becomes possible to implement radio-wave communication, which is inferior to infrared in terms of power consumption.

Also, in the foregoing embodiment, the transmitting apparatus 22 is provided separately from the television 21 and connected to the television 21. However, the transmitting apparatus 22 may also be built into the television 21 as one component thereof.

Furthermore, the communication between the transmitting apparatus 22 and the shutter glasses 23 may also be wired rather than wireless.

### Second Embodiment of the Present Invention

FIG. 29 illustrates a 3D stereoscopic picture viewing system to which a second embodiment of the present invention has been applied, and configured such that a sync signal is transmitted in a wired manner for the first 128 periods.

The 3D stereoscopic picture viewing system 101 in FIG. 29 includes a television 111, shutter glasses 112, and a wired cable 113 that transmits a sync signal.

The functions of the transmitting apparatus 22 shown in FIG. 5 are built into the television 111. The television 111 sends the first 128 periods of the sync signal to the shutter glasses 112 via the wired cable 113. The shutter glasses 112 receive the first 128 periods of the sync signal via the wired cable 113. Once the first 128 periods of the sync signal have been sent and received, the shutter glasses 112 are disconnected from the wired cable 113. In all other respects, the television 111 is similar to the television 21 shown in FIG. 5, and the shutter glasses 112 are similar to the shutter glasses 23 shown in FIG. 5. As a result of the above, the sync signal is received over a wired connection for the first 128 periods, and thus it becomes possible for the sync signal to be reliably received.

### Third Embodiment of the Present Invention

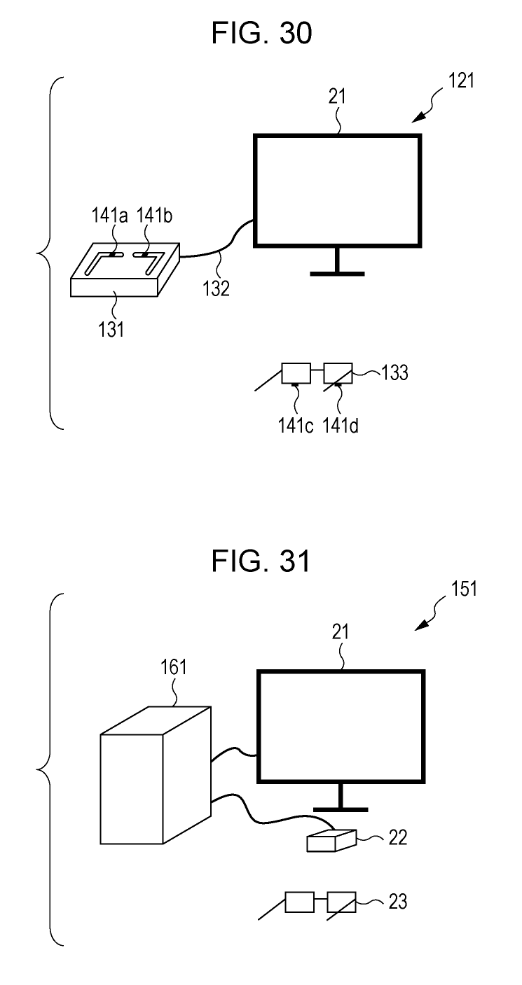

FIG. 30 illustrates a 3D stereoscopic picture viewing system to which a third embodiment of the present invention has been applied.

The 3D stereoscopic picture viewing system 121 shown in FIG. 30 includes a television 21, a cradle 131, a connecting cable 132, and shutter glasses 133.

The cradle 131 includes functions similar to those of the transmitting apparatus 22 shown in FIG. 5, and is connected to the television 21 by the connecting cable 132. In addition, the shutter glasses 133 can be placed on top of the cradle 131. When the shutter glasses 133 are placed on top of the cradle 131, contacts 141a and 141b on the cradle 131 make an electrical connection with contacts 141c and 141d on the shutter glasses 133.

The cradle 131 acquires a sync signal from the television 21 via the connecting cable 132, and sends the sync signal to the shutter glasses 133 placed thereon via the contacts 141a and 141b. Additionally, the cradle 131 includes functions for charging the internal battery of shutter glasses 133 placed thereon.

Also, when the shutter glasses 133 are not placed on the cradle 131, the cradle 131 is able to wirelessly send a sync signal to the shutter glasses 133, similarly to the transmitting apparatus 22.

When the shutter glasses 133 are placed on the cradle 131, a sync signal is received via the contacts 141c and 141d, while the internal battery is also charged. When not placed on the cradle 131, the shutter glasses 133 wirelessly receive a sync signal. In all other respects, the cradle 131 is similar to the transmitting apparatus 22 shown in FIG. 5, and the shutter glasses 133 are similar to the shutter glasses 23 shown in FIG. 5.

Given a 3D stereoscopic picture viewing system 121 configured in this way, the following mode of use is possible.

For example, when not viewing 3D stereoscopic pictures, the user will remove the shutter glasses 133 and place the shutter glasses 133 at some location. In contrast, when the user is going to view 3D stereoscopic pictures, he or she would usually make some preparations, such as playing back a BD-ROM or similar optical disc whereon the 3D stereoscopic picture content is recorded.

Thus, when the user is not viewing 3D stereoscopic pictures, he or she may place the shutter glasses 133 on the cradle 131. Then, the user performs operations to play back 3D stereoscopic picture content, and immediately before the 3D stereoscopic pictures are displayed, the user takes the shutter glasses 133 from the cradle 131 and puts the shutter glasses 133 on.

The above mode of use is made up of actions regularly performed when a user views content, and thus is unlikely to feel bothersome to the user.

In this case, the shutter glasses 133 acquire a sync signal from the cradle 131 over a wired connection via the contacts 141a and 141b, until the period information and the pulse width information for the first 128 periods of the sync signal is measured. The amount of time involved in measuring the period information and the pulse width information for the first 128 periods of the sync signal is a short 2.13 s as described earlier, and thus the time spent performing preparatory operations is amply sufficient for measurement. After the first 128 periods, the shutter glasses 133 communicate wirelessly with the cradle 131 only during phase entrainment. In so doing, the sync signal is received over a wired connection for the first 128 periods, and thus it becomes possible for the sync signal to be reliably received.

Herein, the measurement of the period information and the pulse width information in the shutter glasses 133 can also be made to start when reception of the sync signal begins.

### Fourth Embodiment of the Present Invention

FIG. 31 illustrates a 3D stereoscopic picture viewing system to which a fourth embodiment of the present invention has been applied.

The 3D stereoscopic picture viewing system 151 shown in FIG. 31 includes a television 21, transmitting apparatus 22, and shutter glasses 23 identical to those of the first embodiment shown in FIG. 5, as well as a playback apparatus 161.

In the first embodiment, the television 21 supplies a sync signal to the transmitting apparatus 22. In contrast, in the 3D stereoscopic picture viewing system 151 shown in FIG. 31, the playback apparatus 161 supplies a sync signal to the transmitting apparatus 22.

The playback apparatus 161 supplies the television 21 with 2D picture data for left-eye right-eye pictures based on 3D stereoscopic picture data. In addition, the playback apparatus 161 also supplies the transmitting apparatus 22 with a sync signal. The playback apparatus 161 may be a recording and playback apparatus, personal computer (PC), or similar apparatus that plays back content recorded on a hard disk or optical disc, for example.

According to the 3D stereoscopic picture viewing system 151 shown in FIG. 31, the television adopted as the television 21 can be an existing television provided with neither functions for displaying left-eye and right-eye pictures based on 3D stereoscopic picture data, nor functions for outputting a sync signal.

Method for Handling Phase Misalignment that has Exceeded Allowable Range

In the foregoing embodiment, the self-timing period was determined with the allowable range of phase misalignment assumed to be ±10% of a 4 ms pulse width, or in other words, 400 μs. A method will now be described for handling the case wherein the phase misalignment has exceeded the allowable range, and assuming the self-timing period has ended.

The phase misalignment might exceed the allowable range when, for example, sudden and unexpected temperature variation occurs. In this case, the self-timing period might be mistakenly set, and the powered-off time might become longer than the set values described earlier. Additionally, when the phase misalignment exceeds the allowable range, the timing signal is no longer synchronized with the 3D stereoscopic pictures displayed on the television 21, and the user may no longer perceive the pictures in 3D. Such cases can be handled by the following methods, for example.

A first method involves resetting (i.e., deleting) the period information and pulse width information up to that point, and re-analyzing the period information and the pulse width information by means of the period information analyzer 43. In other words, the first method involves switching from the timing signal generation process using phase entrainment shown in FIG. 26 to the timing signal generation process shown in FIG. 25.

A second method involves storing in advance preset pulse width information in addition to the preset period information in the period information storage unit 44A shown in FIG. 27. Timing signals are then generated using the preset information, without measuring the incoming sync signal.

For example, the sync signal that is received again after the self-timing period ends may be supplied to the self-timing counter 45. In the self-timing counter 45, the phase difference is detected between the supplied sync signal and the timing signals generated by the self-timing counter 45. The phase difference detection results are then supplied to the period information analyzer 43. If the supplied phase difference exceeds an allowable range of phase difference that has been stored in advance, then the period information analyzer 43 supplies the preset period information that was selected when measuring the period information for the first time, as well its corresponding preset pulse width information.

The second method has the advantage of being faster to restore normal operation by the amount of time saved by not re-measuring.

Besides the above first and second methods for handling phase misalignment after the self-timing period has ended, it is also possible to provide a user-operable button (or switch) on the shutter glasses 23, such that when the button is operated by the user, either the above first or second method is conducted. When the phase misalignment is large, the user might no longer perceive the 3D stereoscopic pictures in 3D, or experience a sense of discomfort. In such cases, the shutter glasses 23 conduct the first or second method as a result of the user operating the button. Consequently, it becomes possible for the user to issue instructions for re-generating timing signals at will, irrespective of the allowable range of phase misalignment.

In addition, a three-axis sensor for detecting the tilt of the shutter glasses 23 may also be provided in the shutter glasses 23, such that when the shutter glasses 23 exhibit at least a predetermined amount of tilt, the period information analyzer 43 is made to start measuring the period information and the pulse width information. In this case, the user is able to issue instructions for re-generating timing signals by tilting his or her head, for example, thereby improving usability.

In the present specification, the steps stated in the flowcharts may obviously represent a process conducted in a time series following the order described herein. However, it should be appreciated that the steps may also be executed in parallel or individually, without being processed in a time series.

In the present specification, a system is taken to express the entirety of an apparatus made up of a plurality of devices.

The present application contains subject matter related to that disclosed in Japanese Priority Patent Application JP 2009-125250 filed in the Japan Patent Office on May 25, 2009, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A method of synchronizing a shutter operation of shutter glasses with a video synchronization signal for displayed video, the shutter glasses providing a wearer with a perception of viewing three dimensional video, the method being performed at the shutter glasses, the method comprising:
receiving the video synchronization signal;
generating a self-timing signal synchronized with the video synchronization signal;
entering a low-power mode of operation in which reception of the video synchronization signal is disabled;
controlling the shutter operation based on the self-timing signal;
exiting the low-power mode to enable reception of the video synchronization signal; and
re-synchronizing the self-timing signal with the video synchronization signal.

2. The method of claim 1, wherein the video synchronization signal is received via wireless communication.

3. The method of claim 1, wherein entering the low-power mode comprises disconnecting power from a receiver configured to receive the video synchronization signal.

4. The method of claim 1, wherein the video synchronization signal has a period corresponding to a period of displayed frames of video.

5. The method of claim 1, further comprising:
performing the shutter operation based on the self-timing signal by alternating between:
enabling light to pass through the shutter glasses to the wearer's left eye while preventing light from passing through the shutter glasses to the wearer's right eye; and
enabling light to pass through the shutter glasses to the wearer's right eye while preventing light from passing through the shutter glasses to the wearer's left eye.

6. The method of claim 1, wherein the shutter glasses are controlled to be in the low power mode of operation for a self-timing period in which the shutter operation is controlled independently of the video synchronization signal.

7. The method of claim 6, wherein the self-timing period is selected to be less than a threshold.

8. The method of claim 1, further comprising:
receiving an input from a person; and
in response to receiving the input, exiting the low-power mode and re-synchronizing the self-timing signal with the video synchronization signal.

9. The method of claim 1, further comprising:
determining period information representing the period of the video synchronization signal; and
generating the self-timing signal based on the period information.

10. A circuit for synchronizing a shutter operation of shutter glasses with a video synchronization signal for displayed video, the shutter glasses providing a wearer with a perception of viewing three dimensional video, the circuit comprising:
a receiver configured to receive the video synchronization signal;
a timing generator configured to generate a self-timing signal synchronized with the video synchronization signal; and
a controller configured to:
switch the circuit into a low-power mode by disabling the receiver after the timing generator synchronizes the self-timing signal with the video synchronization signal; and
switch the circuit out of the low-power mode by enabling the receiver so that the timing generator re-synchronizes the self-timing signal with the video synchronization signal.

11. The circuit of claim 10, wherein the video synchronization signal is received via wireless communication.

12. The circuit of claim 10, wherein the receiver is configured to receive an infrared signal.

13. The circuit of claim 10, further comprising:
a switch coupled to the controller to receive a signal causing the switch to disconnect a power source from the receiver.

14. The circuit of claim 10, wherein the video synchronization signal has a period corresponding to a period of displayed frames of video.

15. The circuit of claim 10, further comprising:
a shutter driver that drives the shutter operation based on the self-timing signal to alternate between:
enabling light to pass through the shutter glasses to the wearer's left eye while preventing light from passing through the shutter glasses to the wearer's right eye; and
enabling light to pass through the shutter glasses to the wearer's right eye while preventing light from passing through the shutter glasses to the wearer's left eye.

16. The circuit of claim 10, wherein the controller is configured to control the shutter glasses to be in the low power mode of operation for a self-timing period in which the shutter operation is controlled independently of the video synchronization signal.

17. The circuit of claim 16, wherein the self-timing period is selected to be less than a threshold.

18. The circuit of claim 10, further comprising a period information analyzer configured to analyze the video synchronization signal and determine period information representing a period of the video synchronization signal.

19. The circuit of claim 10, further comprising:
a self-timing counter configured to receive the period information and to generate a self-timing signal to control the shutter operation based on the period information.

20. A method of synchronizing a shutter operation of shutter glasses with a video synchronization signal for displayed video, the shutter glasses providing a wearer with a perception of viewing three dimensional video, the method being performed at the shutter glasses, the method comprising:
receiving the video synchronization signal;
determining period information representing a period of the video synchronization signal;
generating a self-timing signal based on the period information; and
controlling the shutter operation based on the self-timing signal.

21. The method of claim 20, wherein the video synchronization signal is received via wireless communication.

22. The method of claim 20, wherein the period information is determined by averaging a plurality of measured periods of the video synchronization signal.

23. The method of claim 20, further comprising determining pulse width information representing a pulse width of the video synchronization signal, wherein the self-timing signal is generated based on the pulse width information.

24. The method of claim 20, further comprising:
determining whether the video synchronization signal is valid; and
if the video synchronization signal is valid, providing the video synchronization signal to a period information analyzer.

25. The method of claim 20, further comprising:
disabling reception of the video synchronization signal in response to determining the period information.

26. A circuit for synchronizing a shutter operation of shutter glasses with a video synchronization signal for displayed video, the shutter glasses providing a wearer with a perception of viewing three dimensional video, the circuit comprising:
a period information analyzer configured to analyze the video synchronization signal and determine period information representing a period of the video synchronization signal; and
a self-timing counter configured to receive the period information and to generate a self-timing signal to control the shutter operation based on the period information.

27. The circuit of claim 26, further comprising a receiver configured to receive the video synchronization signal via wireless communication.

28. The circuit of claim 26, further comprising a controller configured to control the period information analyzer using a timer that determines when a self-timing period has expired.

29. The circuit of claim 26, wherein the circuit is further configured to determine pulse width information representing a pulse width of the video synchronization signal, and to generate the self-timing signal based on the pulse width information.

30. The circuit of claim 26, further comprising a period information storage unit configured to store the period information and provide the self-timing counter with the period information.

31. A method of synchronizing a self-timing signal with a synchronization signal, the method comprising:
receiving the synchronization signal;
generating a self-timing signal synchronized with the synchronization signal;
controlling a circuit to enter a low-power mode of operation in which reception of the synchronization signal is disabled;
controlling the circuit to exit the low-power mode to enable reception of the synchronization signal; and
re-synchronizing the self-timing signal with the synchronization signal.

32. The method of claim 31, wherein the synchronization signal is received via wireless communication.

33. The method of claim 31, wherein entering the low-power mode comprises disconnecting power from a receiver configured to receive the synchronization signal.

34. The method of claim 31, wherein the synchronization signal is a video synchronization signal having a period corresponding to a period of displayed frames of video.

35. The method of claim 31, wherein the circuit is controlled to be in the low power mode of operation for a self-timing period in which an operation of the circuit is controlled independently of the synchronization signal.

36. The method of claim 35, wherein the self-timing period is selected to be less than a threshold.

37. The method of claim 31, further comprising:
receiving an input from a person; and
in response to receiving the input, exiting the low-power mode and re-synchronizing the self-timing signal with the synchronization signal.

38. The method of claim 31, further comprising:
determining period information representing the period of the synchronization signal; and
generating the self-timing signal based on the period information.

39. A circuit for synchronizing a self-timing signal with a synchronization signal, the circuit comprising:
a receiver configured to receive the synchronization signal;
a timing generator configured to generate a self-timing signal synchronized with the synchronization signal; and
a controller configured to:
switch the circuit into a low-power mode by disabling the receiver after the timing generator synchronizes the self-timing signal with the synchronization signal; and
switch the circuit out of the low-power mode by enabling the receiver so that the timing generator re-synchronizes the self-timing signal with the synchronization signal.

40. The circuit of claim 39, wherein the synchronization signal is received via wireless communication.

41. The circuit of claim 40, wherein the receiver is configured to receive an infrared signal.

42. The circuit of claim 39, further comprising:
a switch coupled to the controller to receive a signal causing the switch to disconnect a power source from the receiver.

43. The circuit of claim 39, wherein the synchronization signal is a video synchronization signal having a period corresponding to a period of displayed frames of video.

44. The circuit of claim 39, wherein the controller is configured to control the circuit to be in the low power mode of operation for a self-timing period in which an operation of the circuit is controlled independently of the synchronization signal.

45. The circuit of claim 44, wherein the self-timing period is selected to be less than a threshold.

46. The circuit of claim 39, further comprising a period information analyzer configured to analyze the synchronization signal and determine period information representing a period of the synchronization signal.

47. The circuit of claim 39, further comprising:
a self-timing counter configured to receive the period information and to generate a self-timing signal to control an operation of the circuit based on the period information.
